(19) United States
(12) Patent Application Publication
(10) Pub. No.: US 2023/0241819 A1
(43) Pub. Date: Aug. 3, 2023

(54) CONVEYOR DEVICE FOR MOVING MOLDS

(71) Applicants: Canon Virginia, Inc., Newport News (VA); Canon, U.S.A., Inc., Melvile, NY (US)

(72) Inventors: Koki Kodaira, Tokyo (JP); Yuichi Yanahara, Moriyama (JP); Junko Tajima, Amsterdamm (NL)

(21) Appl. No.: 18/011,795

(22) PCT Filed: Jun. 15, 2021
(86) PCT No.: PCT/US2021/037483

§ 371 Date: Dec. 20, 2022

Related U.S. Application Data
(60) Provisional application No. 63/042,209, filed on Jun. 22, 2020.
(60) Provisional application No. 63/042,368, filed on Jun. 22, 2020.
(60) Provisional application No. 63/085,789, filed on Sep. 30, 2020.

(51) Int. Cl. B29C 45/17

(52) U.S. Cl. CPC B29C 45/1756; B29C 45/1742

(57) ABSTRACT

A conveyance system for conveying a mold into an injection molding machine includes a conveying machine that conveys the mold, and a supporting member that movably supports the conveying machine, wherein the improvement to the conveyance system includes a guide member that guides a movement of the conveying machine by the supporting member in a direction other than an X-axis direction between a first position where the mold can be conveyed from the conveying machine to the injection molding machine and a second position that is different from the first position.

### CROSS-REFERENCE TO RELATED APPLICATIONS

This application claims the benefit of U.S. Provisional Application 63/085789, which was filed on Sep. 30, 2020, U.S. Provisional Application 63/042368, which was filed on Jun. 22, 2020, and U.S. Provisional Application 63/042209, which was filed on Jun. 22, 2020, and are hereby all incorporated by reference in their respective entirities.

### BACKGROUND

Manufacturing of molded parts by an injection molding machine includes injecting a resin into a mold after clamping the mold, pressing the resin into the mold at a high pressure in order to compensate for a volume decrease due to solidification of the resin, keeping the molded part in the mold until the resin solidifies, and ejecting the molded part from the mold. The injection molding process is repeatedly performed to obtain a desired number of molded parts. After a predetermined number of moldings are performed with one mold, the mold is ejected from the injection molding machine, the next mold is setup, the next mold is inserted into the injection molding machine, and then the predetermined number of injection moldings with the next mold is performed.

After a predetermined number of moldings have been performed with one mold, the mold is ejected from the injection molding machine, the next mold is setup and inserted into the injection molding machine, and then a predetermined number of injection moldings with the next mold is performed. The setup processes can often take up time and resources, and during the setup processes, the injection molding machine can be in an ‘idle’ state. This can negatively impact overall productivity.

In the above-described molding approach, a method that uses two molds with one injection molding machine has been proposed. For example, US 2018/0009146/Japanese patent publication No. 2018-001738/VN20160002505 are seen to discuss a system in which conveying machines are arranged on both sides of an injection molding machine. FIG. 1 illustrates an injection molding system of US 2018/0009146/Japanese patent publication No. 2018-001738/VN20160002505. In this system, carts for moving the molds can be arranged on both sides of the injection molding machine. Therefore, when performing maintenance on the interior of the injection molding machine where the mold is housed, the presence of the carts can make it difficult for an operator to access the interior of the injection molding machine.

### SUMMARY

A conveyance system for conveying a mold into an injection molding machine comprising a conveying machine configured to convey the mold, and a supporting member configured to movably support the conveying machine, wherein the improvement to the conveyance system includes a guide member configured to guide a movement of the conveying machine by the supporting member in a direction other than an X-axis direction between a first position where the mold can be conveyed from the conveying machine to the injection molding machine and a second position that is different from the first position.

### BRIEF DESCRIPTION OF THE DRAWINGS

The accompanying drawings, which are incorporated herein and form part of the specification, illustrate various embodiments, objects, features, and advantages of the present disclosure.

FIG. 1 illustrates an injection molding system.

FIG. 2 is a side view of an injection molding machine.

FIG. 3 is an end view of a fixed platen.

FIG. 4A illustrates a flowchart illustrating a molding process.

FIG. 4B illustrates an improvement to the molding process in FIG. 4A.

FIGS. 5A-5C illustrate a configuration of a conveying machine

FIG. 6 illustrates when the conveying machine is moved to a retracted position.

FIGS. 7A-7C illustrate a first alignment mechanism.

FIGS. 8A-8C illustrate a modification of the first alignment mechanism.

FIGS. 9A-9C illustrate a second alignment mechanism.

FIGS. 10A-10C illustrate a modification of the second alignment mechanism.

FIGS. 11A-11C illustrate a third alignment mechanism.

FIGS. 12A-12B illustrate an alignment method using the third alignment mechanism.

FIG. 13 illustrate a configuration of the conveying machine movable in an X-axis direction.

FIG. 14A illustrates directions in which molds are exchanged.

FIG. 14B illustrates a direction in which molds are exchange according to an exemplary embodiment.

FIG. 15 is a top view and a front view of a conveying machine.

FIG. 16A illustrates a bottom view and a front view of a mold.

FIG. 16B illustrates the size of support boards in relation to size of the bottom surface of a mold.

FIG. 16C illustrates a side view of a mold.

FIG. 16D illustrates a method to determine a smallest dimension for a taper formed in a mold.

FIGS. 17A and 17B illustrate a top view of a conveying device for exchanging molds.

FIGS. 18A-18H illustrate a front view of a conveying device for exchanging molds.

FIGS. 19A and 19B are a front view illustrating a procedure for exchanging molds according to another embodiment.

FIG. 20 illustrates a configuration of a ball roller.

FIGS. 21A, 21B, and 21C illustrate a procedure for exchanging molds with a ball roller.

FIG. 22 is a top view and a front view of a conveying machine.

FIGS. 23A and 23B are a front view illustrating a procedure for exchanging molds.

FIG. 24 is a bottom view and a front view of support boards.

FIGS. 25A and 25B are a bottom view and a front view of support boards.

FIG. 26 is a bottom view and a front view of a mold.

Throughout the Figures, the same reference numerals and characters, unless otherwise stated, are used to denote like features, elements, components or portions of the illustrated embodiments. While the subject disclosure is described in detail with reference to the Figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, an injection molding system according to an embodiment of the present disclosure will be explained. The arrow symbols X and Y in each Figure indicate horizontal directions that are orthogonal to each other, and the arrow symbol Z indicates a vertical (upright) direction with respect to the ground.

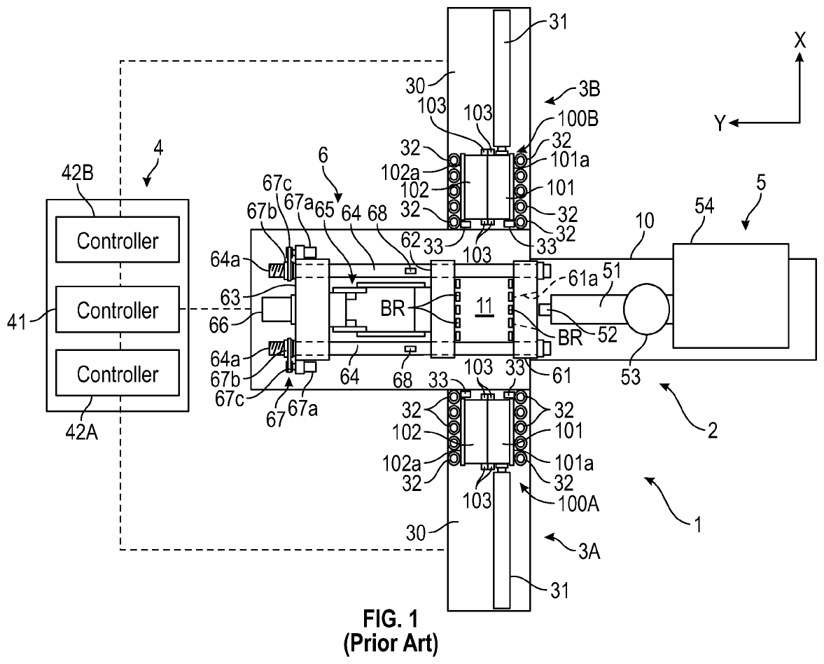

FIGS. 1-3 illustrate injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine 2.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to being an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case where molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

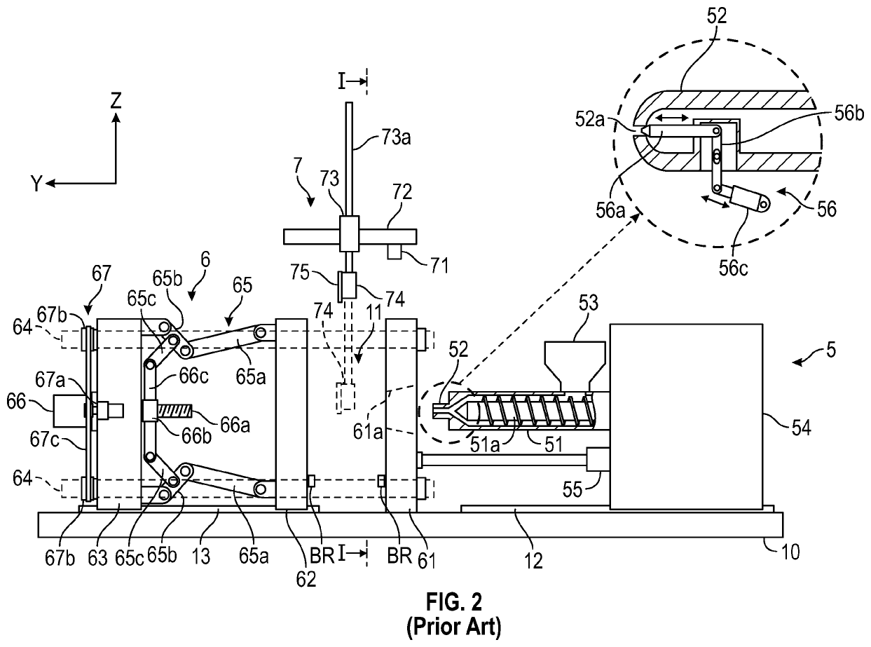

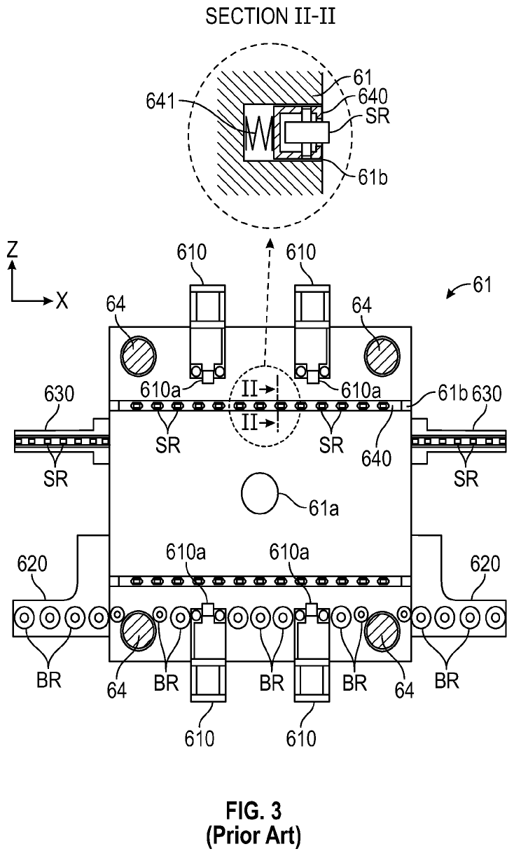

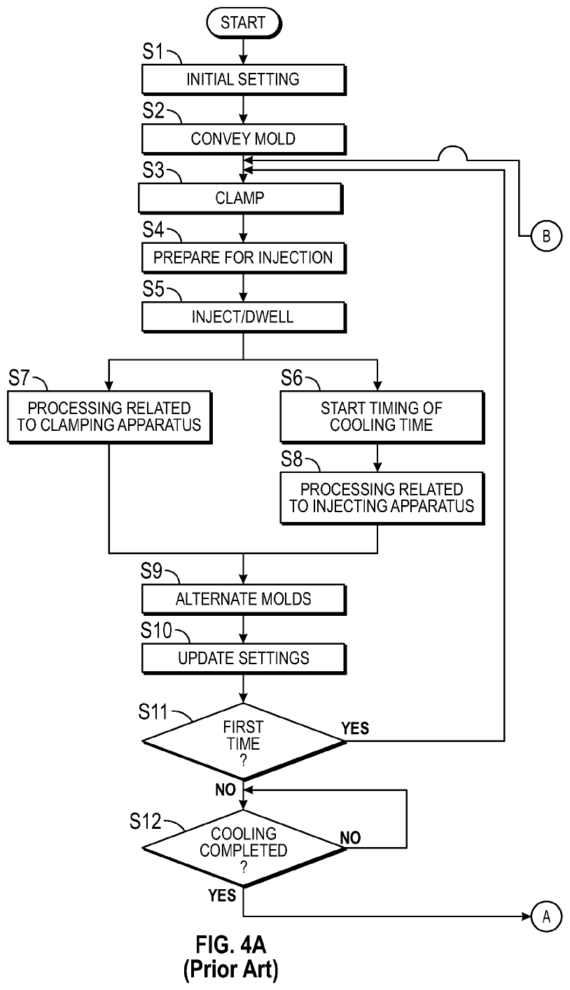

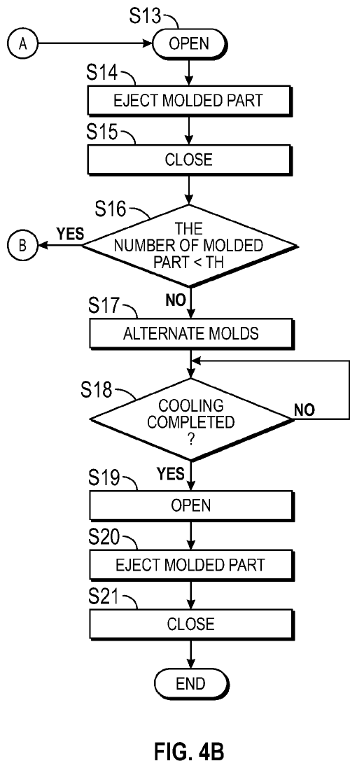

FIG. 2 illustrates a side view of the injection molding machine 2. FIG. 3 illustrates an end view of a fixed platen 61, and a figure viewing from the arrow direction of the I-I line in FIG. 2. FIG. 4 illustrates a partial perspective view for describing the configuration of a periphery of the molding operation position 11.

With reference to FIG. 1 and FIG. 2, the injection molding machine 2 includes an injecting apparatus 5, a clamping apparatus 6, and a take-out robot 7 for ejecting a molded part. The injecting apparatus 5 and the clamping apparatus 6 are arranged on a frame 10 in the Y-axis direction.

The injecting apparatus 5 includes an injection cylinder 51 that is arranged to extend in the Y-axis direction. The injection cylinder 51 includes a heating device (not illustrated) such as a band heater, and melts a resin introduced from a hopper 53. A screw 51a is integrated into the injection cylinder 51, and by rotation of the screw 51a, plasticizing and measuring the resin introduced into the injection cylinder 51 are performed, and by movement in the axial direction (Y-axis direction) of the screw 51a, it is possible to inject a molten resin from an injection nozzle 52.

In FIG. 2, an example of a shut-off nozzle as the nozzle 52 is illustrated. For an opening/closing mechanism 56 of FIG. 2, a pin 56a for opening/closing the discharge port 52a is arranged. The pin 56a is connected with an actuator (a cylinder) 56c via a link 56b, and by the operation of the actuator 56c the discharge port 52a is opened and closed.

The injection cylinder 51 is supported by a driving unit 54. In the driving unit 54, a motor for plasticizing and measuring the resin by rotationally drive the screw 51a, and a motor for driving the screw 51a to move forward/backward in the axial direction are arranged. The driving unit 54 can move forward/backward in the Y-axis direction along a rail 12 on the frame 10, and in the driving unit 54, an actuator (for example, an electrically driven cylinder) 55 for causing the injecting apparatus 5 to move forward/backward in the Y-axis direction is arranged.

The clamping apparatus 6 performs a clamping and opening and closing of the molds 100A/100B. In the clamping apparatus 6, the following are arranged in order in the Y-axis direction: the fixed platen 61, a movable platen 62, and a movable platen 63. Through platens 61 to 63, a plurality of tie-bars 64 pass. Each of the tie-bars 64 is an axis that extends in the Y-axis direction, one end of which is fixed to the fixed platen 61. Each of the tie-bars 64 is inserted into a respective through hole formed in the movable platen 62. The other end of each of the tie-bars 64 is fixed to the movable platen 63 through an adjusting mechanism 67. The movable platens 62 and 63 can move in the Y-axis direction along a rail 13 on the frame 10, and the fixed platen 61 is fixed to the frame 10.

A toggle mechanism 65 is arranged between the movable platen 62 and the movable platen 63. The toggle mechanism 65 causes the movable platen 62 to move forward/backward in the Y-axis direction in relation to the movable platen 63 (in other words, in relation to the fixed platen 61). The toggle mechanism 65 includes links 65a to 65c. The link 65a is connected rotatably to the movable platen 62. The link 65b is pivotably connected to the movable platen 63. The link 65a and the link 65b are pivotably connected to each other. The link 65c and the link 65b are pivotably connected to each other. The link 65c is pivotably connected to an arm 66c.

The arm 66c is fixed on a ball nut 66b. The ball nut 66b engages a ball screw shaft 66a that extends in the Y-axis direction, and moves forward/backward in the Y-axis direction by rotation of the ball screw shaft 66a. The ball screw shaft 66a is supported such that it is free to rotate by the movable platen 63, and a motor 66 is supported by the movable platen 63. The motor 66 rotationally drives the ball screw shaft 66a while the rotation amount of the motor 66 is detected. Driving the motor 66 while detecting the rotation amount of the motor 66 enables clamping, opening, and closing of the mold 100A/100B.

The injection molding machine 2 includes sensors 68 for measuring a clamping force, where each sensor 68 is, for example, a strain gauge provided on the tie-bar 64, and calculates a clamping force by detecting a distortion of the tie-bar 64.

The adjusting mechanism 67 includes nuts 67b supported to freely rotate on the movable platen 63, motors 67a as driving sources, and transfer mechanisms for transferring the driving force of the motors 67a to the nuts 67b. Each of the tie-bars 64 passes through a hole formed in the movable platen 63, and engages with the nut 67b. By causing the nuts 67b to rotate, the engagement positions in the Y-axis direction between the nuts 67b and the tie-bars 64 change. That is, the position at which the movable platen 63 is fixed in relation to the tie-bar 64 changes. With this, it is possible to cause a space between the movable platen 63 and the fixed platen 61 to change, and thereby it is possible to adjust a clamping force or the like.

The molding operation position 11 is a region between the fixed platen 61 and the movable platen 62.

The mold 100A/100B introduced into the molding operation position 11 are sandwiched between the fixed platen 61 and the movable platen 62 and thereby clamped. Opening and closing in based on movement of the movable mold 102 by movement of the movable platen 62 is performed.

FIG. 3 illustrates an opening portion 61a in a central portion of the fixed platen 61 through which the nozzle 52 moves forward/backward. To the surface on the side of the movable platen 62 (called an inner surface) of the fixed platen 61 a plurality of rollers BR are supported such that they are free to rotate. The plurality of rollers BR rotate around the axis of revolution in the Y-axis direction, and cause movement in the X-axis direction of the mold 100A/100B to be smooth, supporting the bottom surfaces (the bottom surface of the clamping plate 101a) of the mold 100A/100B and supporting the mold 100A/100B from below. On both sides in the X-axis direction of the fixed platen 61, a roller supporting body 620 is fixed, and the plurality of rollers BR are supported by the roller supporting body 620. On the inner surface of the fixed platen 61, grooves 61b that extend in the X-axis direction are formed.

The grooves 61b are formed in two rows separated vertically. On each of the grooves 61b a roller unit 640 is arranged. For the roller unit 640, a plurality of rollers SR are supported such that they are free to rotate. The plurality of rollers SR rotate around the axis of revolution in the Z-axis direction, and guide movement in the X-axis direction of the mold 100A/100B contacting the outer surfaces of the mold 100A/100B (the outer surface of the clamping plate 101a) and supporting the mold 100A/100B from the side. As illustrated in the cross sectional view of the line II-II, while the roller unit 640, by a bias of a spring 641, is positioned at a position at which the roller SR protrudes from the groove 61b, at a time of clamping it is retracted in the groove 61b, and positioned at a position at which the roller SR does not protrude from the groove 61b. The roller unit 640 can prevent the inner surfaces of the mold 100A/100B and the fixed platen 61 from contacting and damaging the inner surfaces at a time of alternating the mold 100A/100B, and the roller unit 640 does not impede the inner surface of the fixed platen 61 and the mold 100A/100B being closed at a time of clamping. On both sides in the X-axis direction of the fixed platen 61, a roller supporting body 630 is fixed, and a plurality of rollers SR are supported by the roller supporting body 630.

On the fixed platen 61, a plurality of fixing mechanisms (clamps) 610 are arranged for fixing the fixed mold 101 to the fixed platen 61. Each fixing mechanism 610 includes an engaging portion 610a that engages with the clamping plate 101a, and a built-in actuator (not illustrated) that moves the engaging portion 610a between an engagement position and an engagement release position.

Note that for the movable platen 62, similarly to the fixed platen 61, a plurality of rollers BR, the roller supporting bodies 620 and 630, the roller unit 640, and the fixing mechanism 610 for fixing the movable mold 102 are arranged.

FIG. 4A illustrates an example of a known operation of the injection molding system 1 executed by the controller 41. In the following example, a case in which a molding operation is performed while alternating molds 100A and 100B.

An initial setting is performed in step S1. The operation conditions of the injecting apparatus 5 and the clamping apparatus 6 are registered for both molds 100A and 100B. The operation conditions include, but are not limited to, the amount of resin that is injected at one time, the temperature, the injection speed, the clamping force, the initial value of the position of the movable platen 63 in relation to the tie-bars 64, etc. These operation conditions differ even when the mold 100A and the mold 100B are the same type of mold. Because the mold 100A is used for a first molding operation, the operations conditions related to the mold 100A are automatically set as the operation conditions. Heating of the injection cylinder 51 and plasticizing and measuring of the resin and the like for the first time is also started.

In step S2, the mold 100A is conveyed into the injection molding machine 2. The motor 66 is driven to widen the gap between the fixed platen 61 and the movable platen 62 to slightly wider than the thickness of the mold 100A (the width in the Y direction). Next, the controller 41 transmits an instruction to load the mold 100A to the controller 42A, and the controller 42A drives the conveyance unit 31 to load the mold 100A into the molding operation position 11. The mold 100A is unloaded and the mold 100B loaded at the same time. When loading of the mold 100A completes, a signal indicating load completion is transmitted from the controller 42A to the controller 41. When the signal indicating load completion is received, the motor 66 is driven to bring the fixed platen 61 and the movable platen 62 into close contact with the mold 100A. At this time, it is not necessary to generate a clamping force as it is generated to occur during a molding. The mold 100A is locked to each of the fixed platen 61 and the movable platen 62 by driving the fixing mechanisms 610.

In step S3, clamping of the mold 100A by the fixed platen 61 and the movable platen 62 is performed by driving the motor 66 to drive the toggle mechanism 65. Preparation for injection in relation to the mold 100A is performed. The actuator 55 is driven to move the injecting apparatus 5, causing the nozzle 52 to contact the mold 100A.

In step S5, injection and dwelling of molten resin is performed. More specifically, the injecting apparatus 5 is driven to fill molten resin into a cavity in the mold 100A from the nozzle 52, and to press the resin in the cylinder 51 into the mold 100A at a high pressure in order to compensate for a volume decrease due to the resin solidifying. The actual clamping force is measured by the sensor 68. During molding, the mold 100A thermally expands due to the temperature of the mold 100A gradually rising, and there are cases where a difference arises in the initial clamping force and the clamping force after some time has passed. Thus, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 based on the result of measurement by the sensors 68. The adjustment of the position of the movable platen 63 in relation to the tie-bars 64 can be performed at any timing, e.g., at the timing of steps S7 and S9 in FIG. 4A and steps S13-step S15 in FIG. 4B.

The processing of step S6 and step S8 is performed in parallel to step S7. In step S6, the timing of the cooling time for the molded part in the mold 100A is started. In step S7, processing related to the clamping apparatus 6 is performed. More specifically, locking of the mold 100A by the fixing mechanism 610 is released. After a delay of a predetermined time from step S5, the motor 66 is driven to drive the toggle mechanism 65. This results in removal of the clamping force, the movable platen 62 separates slightly in relation to the fixed platen 61, and a space facilitating alternating the molds is formed.

In step S8, processing related to the injecting apparatus 5 is performed. For example, a dwelling suck back, a nozzle shut-off, a retraction of the injecting apparatus 5 or the like are performed. The dwelling suck back and the nozzle shut-off prevent the molten resin from dripping when the nozzle 52 separates from the mold 100A. These processes can be performed during a delay time prior to causing the movable platen 62 to separate slightly in relation to the fixed platen 61 in step S7.

The dwelling suck back reduces the resin pressure in the injection cylinder 51 and in the molds 100A/100B when, after the dwelling, the screw 51a is retracted. The position to which the screw 51a is retracted in the dwelling suck back can be managed as an absolute position, and can be managed as a relative position in relation to a position of the screw 51a after dwelling completion. The screw 51a can be caused to retract until it is detected that the resin pressure measured by a load cell (not illustrated) installed in the injecting apparatus 5 is reduced to a predetermined pressure.

The nozzle shut-off closes the discharge port 52a of the nozzle 52, and in the example of FIG. 2, the pin 56a closes the discharge port 52a. This operation enables suppressing the leaking of resin. The precision of the measuring of the resin can be improved for the next injection. The foregoing processing provides to prevent the resin from leaking, but there are cases where long threadlike resin is generated between the mold 100A/100B and the nozzle 52 due to the structure of the mold 100A/100B or the type of resin. An apparatus for injecting air into the nozzle 52 can be installed to prevent this from occurring.

In step S9, alternation of the molds 100A/100B is performed. The mold 100A is unloaded from the molding operation position 11 to the conveying machine 3A, and the mold 100B is loaded from the conveying device 3B to the molding operation position 11. The controller 41 transmits an instruction to unload the mold 100A to the controller 42A, and the controller 42A drives the conveyance unit 31 to unload the mold 100A from the molding operation position 11. When unloading of the mold 100A completes, a signal indicating unloading completion is transmitted from the controller 42A to the controller 41. The mold 100A is cooled on the conveying machine 3A. At this time, the closed state of the mold 100A is maintained due to the operation of the self-closing unit 103.

When the signal indicating unloading completion is received, the operation conditions for the mold 100B are set as the operation conditions of the molding operation in step S10. For example, the thickness of the mold 100B (the width of the Y direction), the clamping force and the like are set as the operation conditions of the molding operation. Molding conditions such as injection speed, etc. corresponding to the mold 100B are also set. Measurement of plasticization for the next injection is started. The motor 66 is driven to cause the fixed platen 61 and the movable platen 62 to closely contact the mold 100B. At this time, it is not necessary to cause a clamping force as is caused to occur during molding to occur. The mold 100B is locked to both the fixed platen 61 and the movable platen 62 by driving the fixing mechanism 610.

After step S9 in the present embodiment, step S10 is performed. However, since it can take time to switch the molding operation conditions, the molding operation conditions can, for example, be switched simultaneously to the instruction to unload the mold 100A.

In step S11, it is determined whether the molding operation is the first molding operation in relation to the molds 100A and 100B. If the molding operation is the first molding operation, the process returns to step S3. If the molding operation is not the first molding operation, i.e., a second, third, etc. molding operation, the process proceeds to step S12.

The above-described process described a first molding operation. As such, the process returns to step S3. The processing of step S3 to step S8 is then executed for the mold 100B.

After the processing of step S3 to step S8 is executed for the mold 100B, the mold 100B is unloaded in step S9, and loading of the mold 100A is performed. The mold 100B is cooled on the conveying device 3B. In step S11, it is determined that the molding operation is not the first molding operation, and the process proceeds to step S12.

In step S12, it is determined whether the cooling of the mold 100A has been completed based on whether the cooling time from the start of the time measurement in step S6 has reached a predetermined time. If cooling has been completed, the processing of step S13 to step S16 in FIG. 4B is performed.

In step S13, the movable platen 62 is separated from the fixed platen 61 by driving the motor 66. The fixed mold 101 is fixed to the fixed platen 61 by the fixing mechanisms 610, while the movable mold 102 is fixed to the movable platen 62 by the fixing mechanisms 610. Therefore, the movable mold 102 separates from the fixed mold 101 and the mold 100A is opened against a force of the self-closing unit 103. In step S14, the molded part remaining on the side of the movable mold 102 of the mold 100A is removed by driving the take-out robot 7, and conveyed out of the injection molding machine 2. The vacuum head 74 is moved to a position where the chuck plate 75 faces the molded par, and the molded part is secured by a suction force.

In step S15, the movable platen 62 is brought close to the fixed platen 61 by driving the motor 66. The movable mold 102, which was previously separated from the fixed mold 101, closely contacts with the fixed mold 101, and the mold 100A is closed. When the injection molding operation is using mold 100B, steps S13, S14, and S15 are executed to remove molded parts from the mold 100B

In step S16, the controller 41 compares the number of currently produced molded parts and a threshold value TH. The number of currently produced molded parts is stored in ROM and/or RAM. The threshold value TH is the desired production quantity and is set in step S1. If the number of currently molded parts is less than the threshold value TH, the flow returns to step S3. At that point, the above processing repeats.

If the number of currently molded parts equals the threshold value TH, the flow proceeds to step S17. The processing in steps S17 to S21 is for removing the molded parts from the other mold, e.g., mold 100B.

In step S17, the molds 100A/100B are alternated in the same manner described in step S9. In the present step, the mold 100A is unloaded from the molding operation position 11 to the conveying machine 3A, while the mold 100B is loaded from the conveying device 3B to the molding operation position 11. The controller 41 transmits an instruction to unload the mold 100A to the controller 42A, and the controller 42A drives the conveyance unit 31 to unload the mold 100A from the molding operation position 11. When unloading of the mold 100A completes, a signal indicating unloading completion is transmitted from the controller 42A to the controller 41.

After receipt of the signal indicating unloading completion, in step S18, it is determined whether cooling of the mold 100B has been completed based on whether the cooling time started in step S6 has reached a predetermined time. If the cooling has completed, the process proceeds to step S19.

In step S19, the movable platen 62 is separated from the fixed platen 61 by driving the motor 66. The fixed mold 101 is fixed to the fixed platen 61 by the fixing mechanisms 610, while the movable mold 102 is fixed to the movable platen 62 by the fixing mechanisms 610. The movable mold 102 separates from the fixed mold 101, and the mold 100A is opened against the force of the self-closing unit 103. The molded part remaining on the side of the movable mold 102 of the mold 100A is removed by driving the take-out robot 7 in step S20, and conveyed outside the injection molding machine 2. The vacuum head 74 is moved to a position where the chuck plate 75 faces the molded part and the molded part is secured held by a suction force. In step S21, the movable platen 62 is brought close to the fixed platen 61 by driving the motor 66. The movable mold 102, which was previously separated from the fixed mold 101, closely contacts with the fixed mold 101, and the mold 100A is closed. When the injection molding operation is using mold 100B, steps S19, S20, and S21 are executed to remove molded parts from the mold 100B.

As described above, in the present embodiment, cooling of the molds 100A and 100B is performed on the conveying machines 3A and 3B outside the injection molding machine 2. During cooling of one of the molds 100A and 100B, each process of molded part removal, mold clamping, injection, and dwelling is performed by the injection molding machine 2 for the other mold 100A/100B. Since opening and molded part removal are performed by the injection molding machine 2, the conveying machines 3A and 3B do not need to have functions for opening and molded part removal. Thus, it is possible to manufacture a molded part while alternating the molds 100A and 100B with the one injection molding machine 2 while suppressing cost increase of the injection molding system.

If the time required for all processes from the start of the mold replacement process, to the removal process for the other mold, injection process, and dwelling process, and up until completion of the mold replacement process once again fits into the time required for cooling one of the molds 100A or 100B, then productivity compared to normal molding is improved by at least two times. That is, in addition to suppressing cost increases, higher productivity can be achieved.

In order to realize twice the level of productivity, it is sufficient that the cooling time of the molds 100A and 100B cover 50% or more of the total molding process (the time for one molding cycle), but this depends on the time for the mold replacement process. Many molded parts used for exterior covering parts or electromechanical parts, such as for automobiles, home electric appliances, office devices or the like, have a thickness of several millimeters to ensure strength. Thus, during the total molding process, the cooling process covers the longest time, and it is not uncommon for the time to cool the molds 100A and 100B to reach from 50% to 70% in relation to the time for one molding cycle. Therefore, the above-described embodiment is particularly effective in improving productivity of this type of molded part. The productivity can be particularly improved if the time for the molding cycle of the mold 100A and the time for the molding cycle of the mold 100B are approximately the same, while the time for cooling the molds 100A and 100B in relation to the time for one molding cycle is greater than or equal to 50%.

Even if the thickness of the molded part is approximately 1 mm and is comparatively thin, there is a tendency for the cooling process to become longer in cases of parts for which high dimensional precision is required, for molded parts that use a resin for which a high temperature is required as a mold temperature, or for a crystalline resin where cooling is time consuming. In the above-described embodiment, it is possible to realize close to two times the productivity when manufacturing a wide variety of molded parts.

If the time to cool the molds 100A and 100B is less than 50% of the time for one molding cycle, effective application of the time for cooling enables the realization of 1.5 times or 1.8 times higher productivity in relation to normal molding.

Based on the above-described embodiment, the installation space and the power consumption can be reduced due to achieving the productivity of two injection molding machines by the conventional manufacturing method in the one injection molding machine 2.

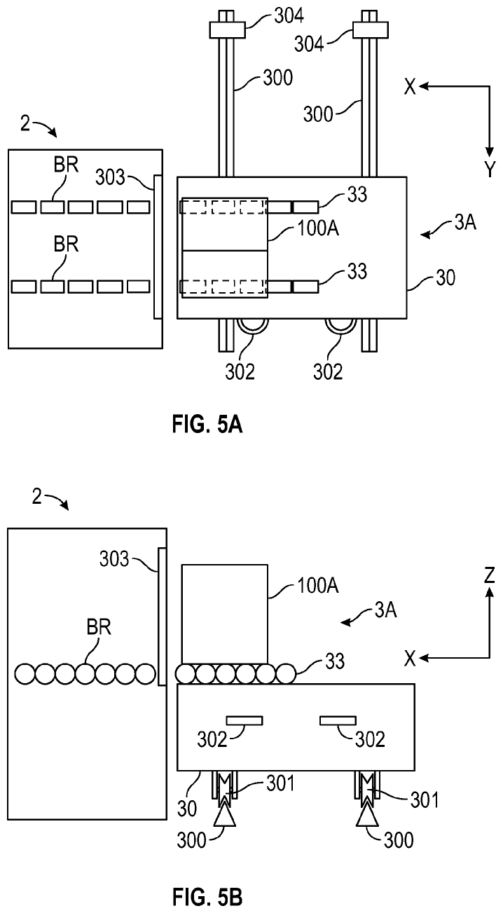

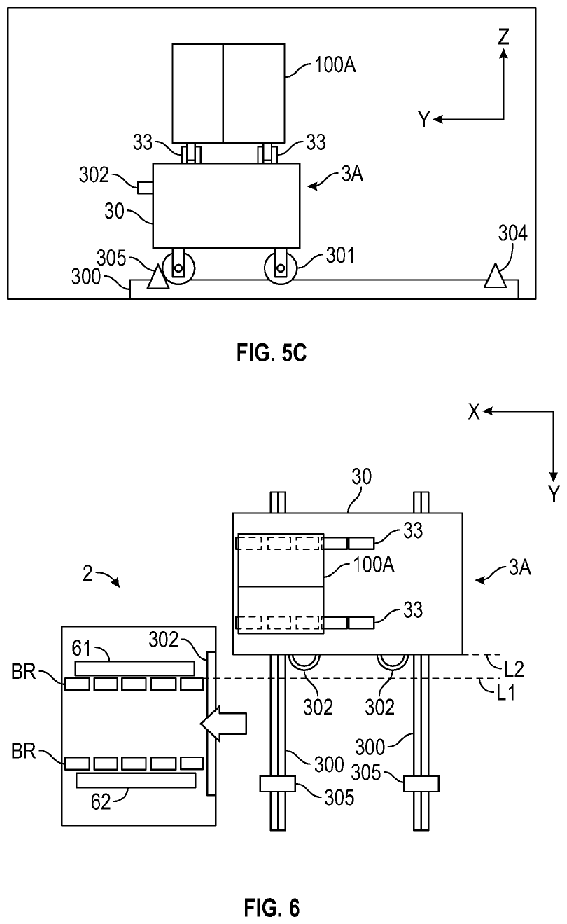

FIGS. 5A-13 illustrate improvements provided by the present disclosure over current injection molding systems. Components of known injection molding systems are included in the description of FIGS. 5A-13 for description purposes only. The following discussion of FIGS. 5A-13 will be provided with respect to the mold A for description purposes only.

FIGS. 5A-5C illustrate a configuration of the conveying machine 3A. More specifically, FIG. 5A illustrates a top view of the injection molding machine 2 and the conveying machine 3A, FIG. 5B illustrates a front view of the injection molding machine 2 and the conveying machine 3A, and FIG. 5C illustrates a side view of the conveying machine 3A.

In FIG. 5A, rails 300 (guiding members) extending in the Y-axis direction are illustrated. In FIG. 5B, the rails 300 are triangular in shape when viewed from the Y-axis direction, and engage with wheels 301 (rotating members) provided on a bottom surface of the frame 30 of the conveying machine 3A. Because V-shaped grooves are formed in the wheels 301, the wheels 301 are configured to engage with the rails 300. Since the wheels 301 rotate while engaged with the rails 300, the conveying machine 3A moves along the rails 300. This enables the conveying machine 3A to move in the Y-axis direction.

Handles 302 are provided on the frame 30 and enable an operator to move the conveying machine 3A. In another exemplary embodiment, the handles 302 are provided on a different surface. As illustrated in FIG. 5C, the rails 300 are provided with stoppers 304 and 305, respectively, to prevent the conveying machine 3A from being moved more than necessary in the Y-axis direction. The stoppers 304 are provided at a position corresponding to the retracted position where the conveying machine 3A retracts from the injection molding machine 2. The stoppers 305 are provided at a position corresponding to a molding operation position where the injection molding machine 2 and the conveying machine 3A are aligned in a straight line.

A locking mechanism (not shown) for regulating the movement of the wheels 301 is separately provided. The movements of the handles 302 and the movements of the locking mechanism can be linked. That is, the configuration can be such that the locking mechanism releases when an operator pushes up the handles 302, and the conveying machine 3A becomes movable. The operator can move the conveying machine 3A by pushing the conveying machine 3A in a negative Y-axis direction while pushing up the handles 302. The conveying machine 3A, the rails 300, the stoppers 304, and the stoppers 305 are collectively referred to as a conveying system.

An opening 303 is formed in the injection molding machine 2. The mold 100A conveyed from the conveying machine 3A passes through the opening 303 and into the injection molding machine 2. If resin was previously injected into the mold 100A and a cooling process previously completed, a molded part will be removed from the mold 100A by the take-out robot 7 after the mold 100A has moved to the molding operation position 11 inside the injection molding machine 2.

In some instances, the molded part cannot easily be removed, and a part of the molded part or the whole part remains inside the mold 100A. If the next injection molding process is performed with the molded part remaining in the mold 100A, there is a possibility that the mold 100A can deform or the injection molding system can fail. Therefore, in such instances, an operator needs to access inside the injection molding machine 2 via the opening 303 and remove the residual molded part from the mold 100A. It can also become necessary for an operator to access inside the injection molding machine 2 during periodic maintenance operations such as cleaning a cavity surface (surfaces of the fixed mold 101 and the movable mold 102 facing each other) of the mold 100A.

FIG. 6 illustrates when the conveying machine 3A is moved to a retracted position. Comparing this configuration with the configuration of FIG. 5A, an operator can easily access inside the injection molding machine 2 via the opening 303 since the conveying machine 3A retracts from a position adjacent to the opening 303 of the injection molding machine 2. It is desirable to move the conveying machine 3A so an end face L2 of the frame 30 is positioned at least more in a negative direction of the Y-axis than an end face L1 of the fixed platen 61 because sufficient space can be secured for the operator. Thus, maintainability improves for the operator.

The end face L1 of the fixed platen 61 is the end face of the fixed platen 61 that faces the movable platen 62, and the end face L2 of the frame 30 is the end face of the frame 30 that is positioned on an upstream side in a direction the conveying machine 3A moves. In other words, a configuration enabling the conveying machine 3A to move so the conveying machine 3A settles in a position downstream from the end face L1 in the direction in which the conveying machine 3A moves is preferable.

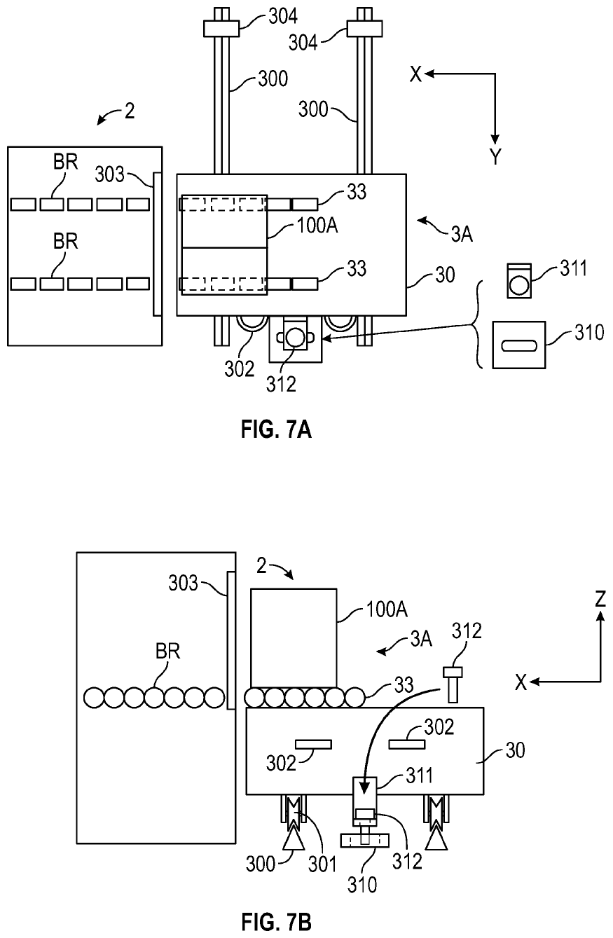

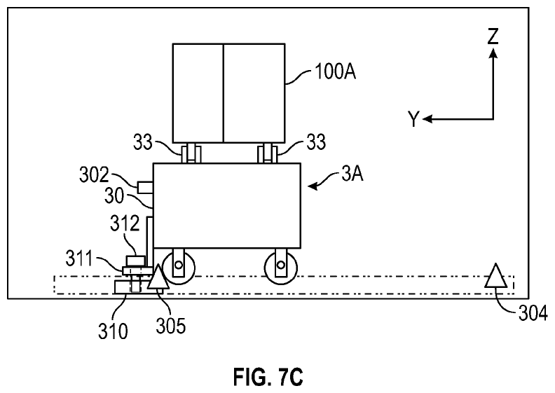

Next, an alignment mechanism for aligning the position of the conveying machine 3A with respect to the injection molding machine 2 after returning the conveying machine 3A from the retracted position to the molding operating position will be explained with reference to FIG. 7A through FIG. 10C. As described above, the molding operation position is a position where the injection molding machine 2 and the conveying machine 3A are aligned in a straight line in the X-axis direction and the mold 100A can be conveyed from the conveying machine 3A into the injection molding machine 2.

FIGS. 7A-7C illustrate a first alignment mechanism. In this configuration, the conveying machine 3A is fixed to the floor using a metal pin. The floor includes a pin fixing part 310 and the frame 30 of the conveying machine 3A includes a pin receiving part 311. The pin fixing part 310 is fixed to the floor in advance with high accuracy positioning with respect to the injection molding machine 2. As illustrated in FIG. 7A, an elongated hole is formed in the pin fixing part 310 into which the pin 312 is to be inserted, where the elongated hole is elongated in the X-axis direction. The size of the elongated hole in the Y-axis direction is designed based on the size of the pin 312.

The movement of the conveying machine 3A in the X-axis direction is controlled by the engagement between the rails 300 and the wheels 301. In other words, only the position in the Y-axis direction needs to be positioned with high accuracy using the pin 312 since the position of the conveying machine 3A in the X-axis direction is maintained with high accuracy almost without changing due to the engagement of the rails 300 with the wheels 301. A hole for inserting the pin 312 is also formed in the pin receiving part 311. This hole is not an elongated hole, but a round hole designed based on the size of the pin 312.

The operator returns the conveying machine 3A from the retracted position to the molding operation position while holding the handles 302, and stops the conveying machine 3A at a position where the round hole formed in the pin receiving part 311 and the elongated hole formed in the pin fixing part 310 overlap. Because the stoppers 305 are provided at a position corresponding to the molding operation position, the operator first moves the conveying machine 3A to a position where the wheels 301 encounter the stoppers 305. Then, the operator need only finely adjust the position of the conveying machine 3A. Next, the operator inserts the pin 312 into the pin receiving part 311 from above, and inserts the pin 312 into the pin fixing part 310 after passing it through the pin receiving part 311. After the pin 312 is inserted into the pin fixing part 310, the pin 312 is fixed by the pin fixing part 310 so that the pin 312 does not come out. Thus, the position of the conveying machine 3A can be fixed with respect to the injection molding machine 2, and the conveying of the mold 100A from the conveying machine 3A to the injection molding machine 2 can re-start.

The pin fixing part 310 and the stoppers 305 are provided independently of each other in the present exemplary embodiment. In another exemplary embodiment, the base portion of the pin fixing part 310 can extend in the X-axis direction to a position where it overlaps with the rails 300 to serve as the stoppers 305 concurrently. In this exemplary embodiment, it is preferable to extend the pin fixing part 310 so it covers not only one rail 300 but both the rails 300.

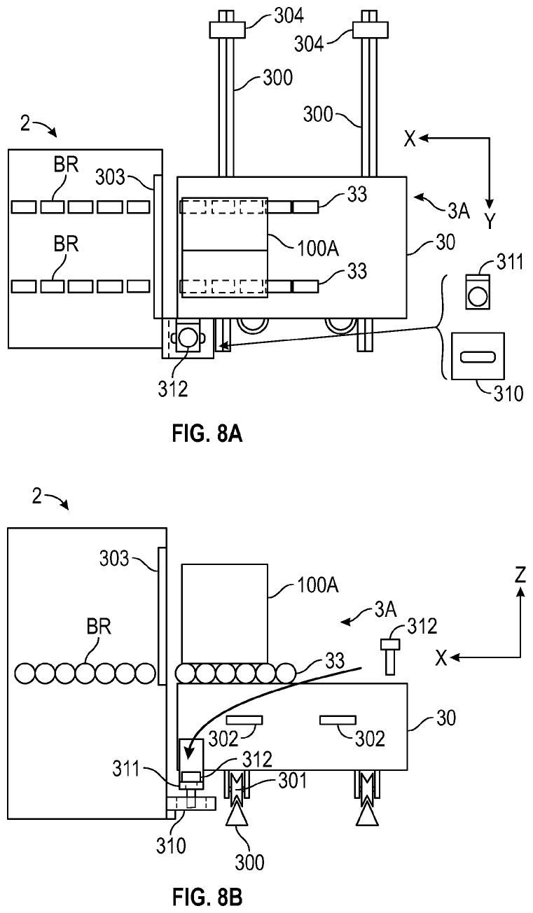

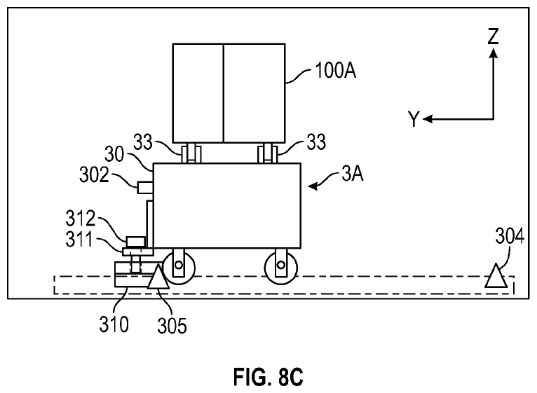

The conveying machine 3A is fixed to the floor in the present exemplary embodiment. In another exemplary embodiment, the conveying machine 3A can be fixed to the injection molding machine 2 as illustrated in FIGS. 8A-8C. That is, the pin fixing part 310 is not fixed to the floor, but is fixed to the injection molding machine 2. According to this configuration, when the pin fixing part 310 is fixed to the floor, the workload of measuring the position with high accuracy so the conveying machine 3A does not misalign with respect to the injection molding machine 2 is reduced. A metal pin is used in the present exemplary embodiment, but if there is no issue with the material strength, considering the weight of the conveying machine 3A, another type of material can be used for the pin.

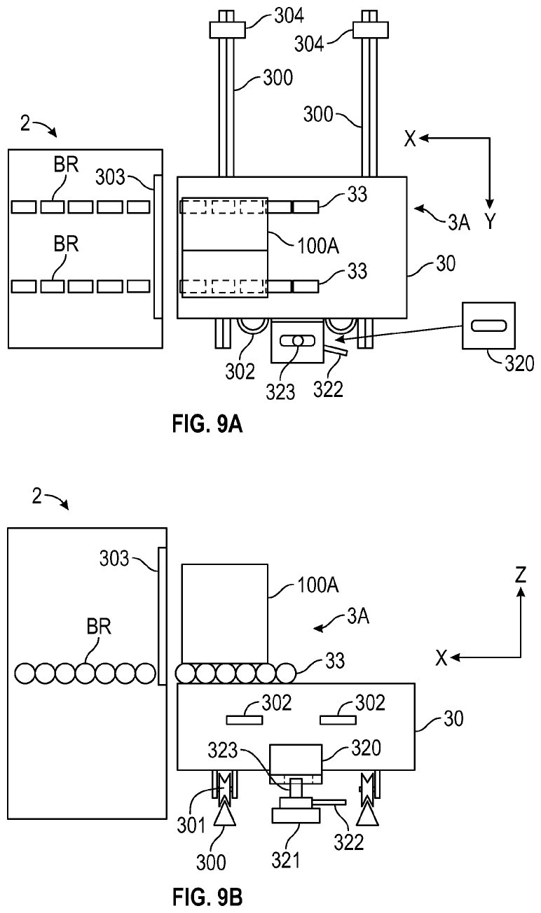

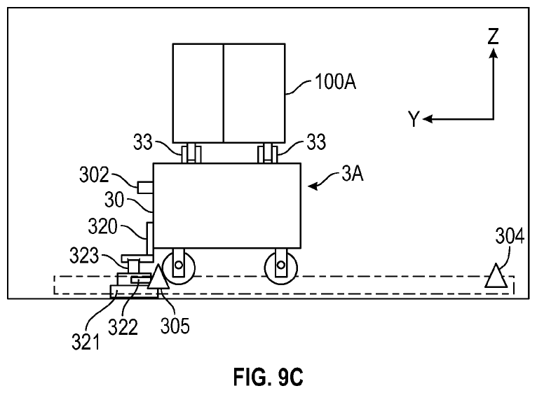

FIGS. 9A-9C illustrate a second alignment mechanism. In this configuration, the conveying machine 3A is fixed to the floor using a metal pin in the same way as in the configuration of FIGS. 7A-7C. A pin protrusion part 321 is located on the floor, and a pin receiving part 320 is located on the frame 30 of the conveying machine 3A. The pin protrusion part 321 is fixed to the floor in advance in a condition with high accuracy positioning with respect to the injection molding machine 2. As described in FIG. 8A, an elongated hole is formed in the pin receiving portion 320 so that the pin 323 that is protruding from the pin protrusion portion 321 can be inserted therein, where the elongated hole is elongated in the X-axis direction. The size of the elongated hole in the Y-axis direction is designed based on the size of the pin 323. The movement of the conveying machine 3A in the X-axis direction is controlled by the engagement between the rails 300 and the wheels 301.

The movement of the conveying machine 3A in the X-axis direction is controlled by the engagement between the rails 300 and the wheels 301. In other words, only the position in the Y-axis direction needs to be positioned with high accuracy using the pin 323 since the position of the conveying machine 3A in the X-axis direction is maintained with high accuracy almost without changing due to the engagement of the rails 300 with the wheels 301. The pin protrusion part 321 includes a lever 322, and the pin 323 can protrude or retract in the Z-axis direction by an operator pulling or pushing the lever 322.

An operator returns the conveying machine 3A from the retracted position to the molding operation position while holding the handles 302, and stops the conveying machine 3A at a position where the elongated hole formed in the pin receiving part 320 and the pin 323 included in the pin protrusion part 321 overlap. Because the stoppers 305 are provided at a position corresponding to the molding operation position, the operator first moves the conveying machine 3A to a position where the wheels 301 encounter the stoppers 305, where the operator only has to finely adjust the position of the conveying machine 3A. Next, the operator pulls the lever 322 to let the pin 323 protrude from the pin protrusion part 321. The pin 323 is inserted into an elongated hole formed in the pin receiving part 320, and the position of the conveying machine 3A is fixed. After the pin 323 is inserted into the pin receiving part 320, it is preferable that the lever 322 is fixed so the pin 323 does not come out. Thus, the position of the conveying machine 3A can be aligned with respect to the injection molding machine 2, and the conveying of the mold 100A from the conveying machine 3A into the injection molding machine 2 can re-start.

In the present embodiment, the pin protrusion part 321 and the stoppers 305 are provided independent of each other. In another exemplary embodiment, the base portion of the pin protrusion part 321 can be extended in the X-axis direction to a position where it overlaps with the rails 300 to serve as the stoppers 305 concurrently. In this embodiment, it is preferable to extend the pin fixing part 310 so it can not only one rail 300, but both the rails 300.

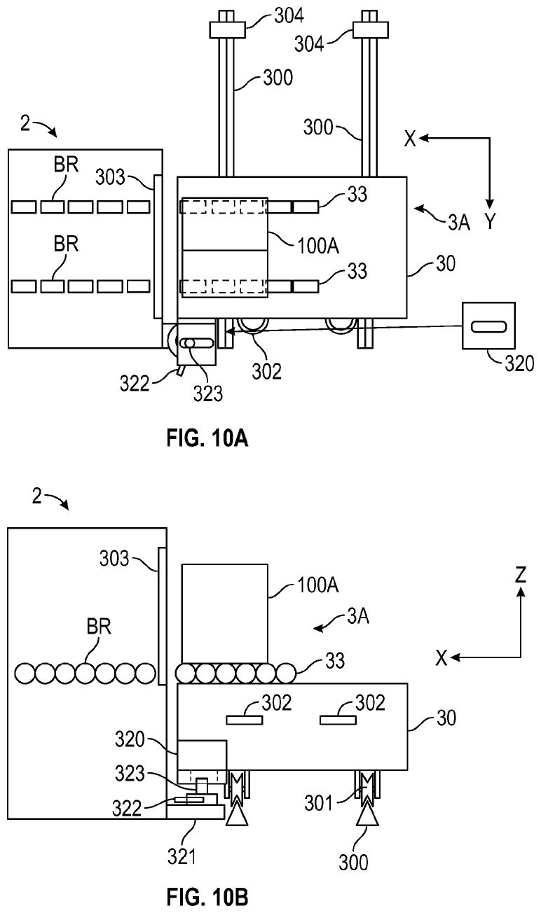

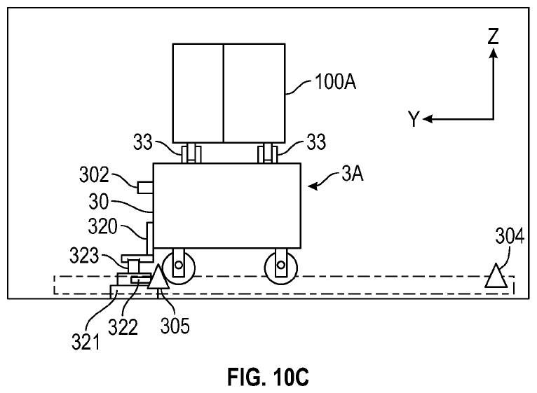

In the present embodiment, the conveying machine 3A is fixed to the floor. In another exemplary embodiment, the conveying machine 3A can be fixed to the injection molding machine 2 as illustrated in FIGS. 10A-10C. That is, the pin protrusion part 321 is not fixed to the floor, but is fixed to the injection molding machine 2. According to this configuration, when the pin protrusion part 321 is fixed to the floor, the workload of measuring the position with high accuracy so the conveying machine 3A does not misalign with respect to the injection molding machine 2 is reduced.

A metal pin is used in the present embodiment, but if there is no issue with the material strength, considering the weight of the conveying machine 3A, another type of material can be used for the pin. A lever-type ejector pin is used in the present embodiment. In another exemplary embodiment, the conveying machine 3A can be automatically fixed by the force of a spring by using a member, such as a plunger, without the operator operating the lever.

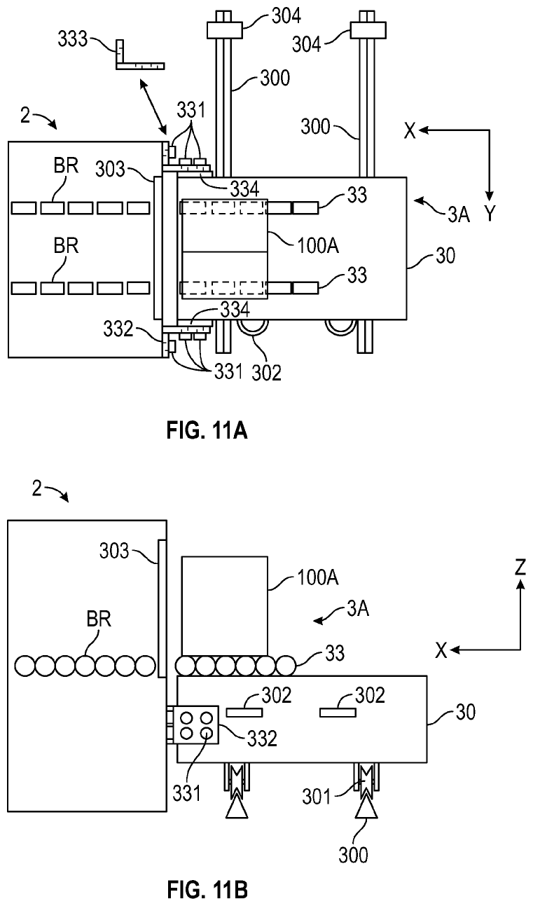

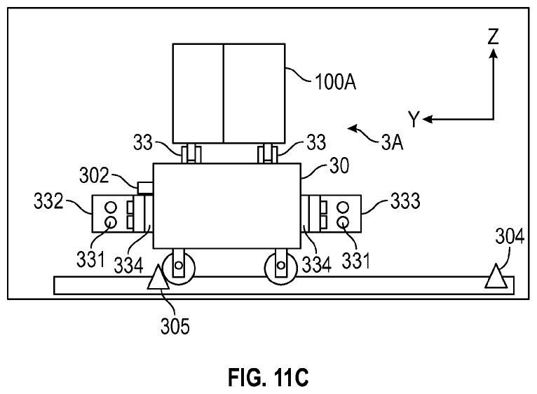

FIGS. 11A-11C illustrates a third alignment mechanism. In this configuration, the conveying machine 3A is fixed to the injection molding machine 2 using an L-shaped bracket. As illustrated in FIG. 11A, plates 334, which include tap holes, are provided on both side surfaces of the frame 30 of the conveying machine 3A. Bolts 331 are inserted into the tap holes via an L-shaped bracket 332 and an L-shaped bracket 333 and fixed to the plates 334. Thus, the L-shaped bracket 332 and the L-shaped bracket 333 are fixed to the conveying machine 3A. The L-shaped bracket 332 and the L-shaped bracket 333 are also fixed to the injection molding machine 2. Consequently, the conveying machine 3A is fixed with respect to the injection molding machine 2. The bolt 331 and the L-shaped bracket 333 are detachable so that the conveying machine 3A can be moved in the Y-axis negative direction.

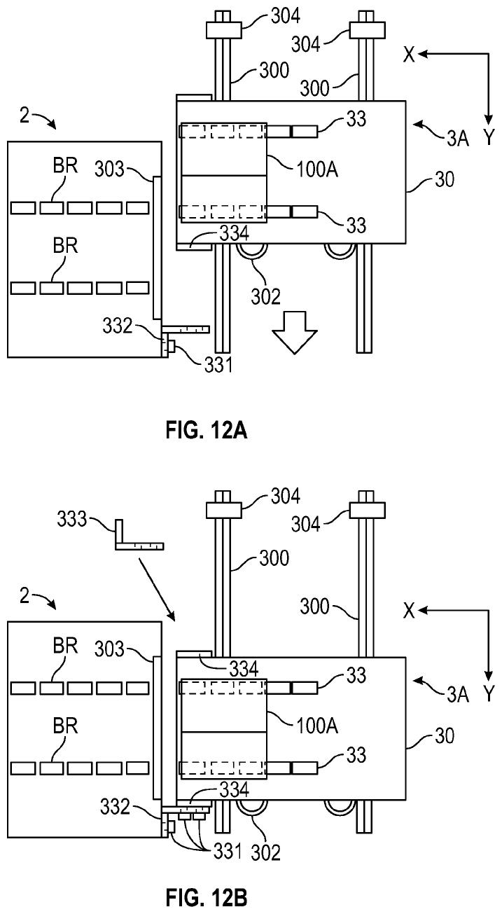

Next, a procedure for returning the conveying machine 3A from the retracted position to the molding operation position will be explained using FIGS. 12A-12B. As illustrated in FIG. 12A, when moving the conveying machine 3A, the L-shaped bracket 333 is removed, and only the L-shaped bracket 332 is attached to the injection molding machine 2. An operator can return the conveying machine 3A from the retracted position to the molding operation position while holding the handles 302, and moves the conveying machine 3A in the direction of the arrow depicted in FIG. 12A.

The conveying machine 3A stops at the position where the plate 334 of the conveying machine 3A positioned on the Y-axis positive side and the L-shaped bracket 332 contact each other. In the present embodiment, the stoppers 305 are provided at a position corresponding to the molding operation position as illustrated in FIG. 11C. In another exemplary embodiment, they can be omitted.

If the L-shaped bracket 332 is provided with sufficient strength, the plate 334 can fulfill the same role as the stopper 305 by abutting against the L-shaped bracket 332. After the L-shaped bracket 332 is fixed to the plate 334, the L-shaped bracket 333 is also fixed to the plate 334 as illustrated in FIG. 12B. Thus, the position of the conveying machine 3A can be aligned with respect to the injection molding machine 2, and the conveying of the mold 100A from the conveying machine 3A to the injection molding machine 2 can re-start.

In the above-described embodiment, when moving the conveying machine 3A from the molding operation position 11 to the retracted position, the fixtures that fix the conveying machine 3A and cables connected to the mold 100A need to be removed. After the conveying machine 3A is moved from the retracted position to the molding operation position 11, the cables are connected to the mold 100A before starting the molding operation.

The above-described embodiment describes a configuration where an operator holds the handles 302 and manually moves the conveying machine 3A. In another exemplary embodiment, a configuration includes an actuator, such as a motor, that can be provided separately to move the conveying machine 3A automatically based on instructions from an operator.

The above-described embodiment describes a configuration where the conveying machine 3A can move in the Y-axis negative direction. In another exemplary embodiment, the conveying machine 3A can move in a reverse direction, i.e., in the Y-axis positive direction.

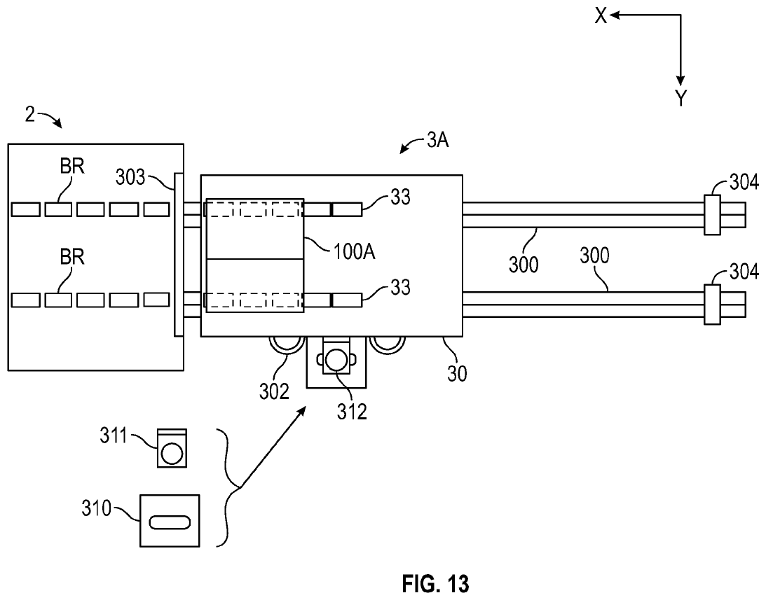

The above-described embodiment describes a configuration where the conveying machine 3A can move along the Y-axis direction. In another exemplary embodiment, illustrated in FIG. 13, the conveying machine 3A can include a configuration movable along the X-axis direction. In this case, the rails 300 extend in the X-axis direction. Because the configuration illustrated in FIG. 13 is the same as the configuration illustrated in FIG. 7 except for the direction the rails 300 extend, a detailed description thereof will be omitted herein. In a configuration where the conveying machine 3A is moved in the X-axis direction, it is preferable that the conveying machine 3A can be separated from the injection molding machine 2 anywhere from several tens of centimeters to several meters to secure a space large enough for an operator to enter between the injection molding machine 2 and the conveying machine 3A.

The above-described embodiment describes a configuration where the conveying machine 3A is movable with respect to the injection molding machine 2. In another exemplary embodiment, the conveying machine 3B, instead of the conveying machine 3A, can be moved in the Y-axis direction or the X-axis direction. In still yet another exemplary embodiment, the conveying machine 3A and the conveying machine 3B can be moved.

The above-described embodiment describes a configuration where the triangular shaped rails 300 are engaged with the wheels 301, in which V-shaped grooves are formed as described above. In another exemplary embodiment, rails with recessed grooves formed in them engage with rollers that include a width that fit exactly in the grooves. In yet another exemplary embodiment, rotating members, such as wheels or rollers, are arranged on the rails and grooves that engage with the rotating members are formed in the bottom surface of the conveying machine 3A.

In still yet another exemplary embodiment, a magnet, for example, is used to reduce the frictional force between the bottom surface of the conveying machine 3A and the rails, and sliders that engage with the grooves of the rails are provided on the bottom surface of the conveying machine 3A. In this exemplary embodiment, rotating members, such as wheels or rollers, do not have to be provided on the bottom surface of the conveying machine 3A. That is, members such as the wheels 301 provided in the conveying machine 3A or the above-described rollers and sliders are supporting members for supporting the conveying machine 3A from below. These supporting members movably support the conveying machine 3A in the direction in which the rails 300 extend.

In the above-described embodiment, the rails 300 are arranged on the floor as guiding members. In another exemplary embodiment, the rollers are arranged on the bottom surface of the conveying machine 3A, and the rollers roll directly on the floor. In yet another exemplary embodiment, sidewalls (convex part) that guide the movements of the conveying machine 3A are formed on both sides of the conveying machine 3A to control the movements of the conveying machine 3A. That is, when moving the conveying machine 3A in the Y-axis direction, the sidewalls extend in the Y-axis direction on both side surfaces of the conveying machine 3A. When moving the conveying machine 3A in the X-axis direction, the sidewalls extend in the X-axis direction on both side surfaces of the conveying machine 3A.

The above-described configuration was explained based on a premise that two molds are used in the injection molding system 1, but is not limited to this. The above-described configuration can be applied to an injection molding system that uses one mold.

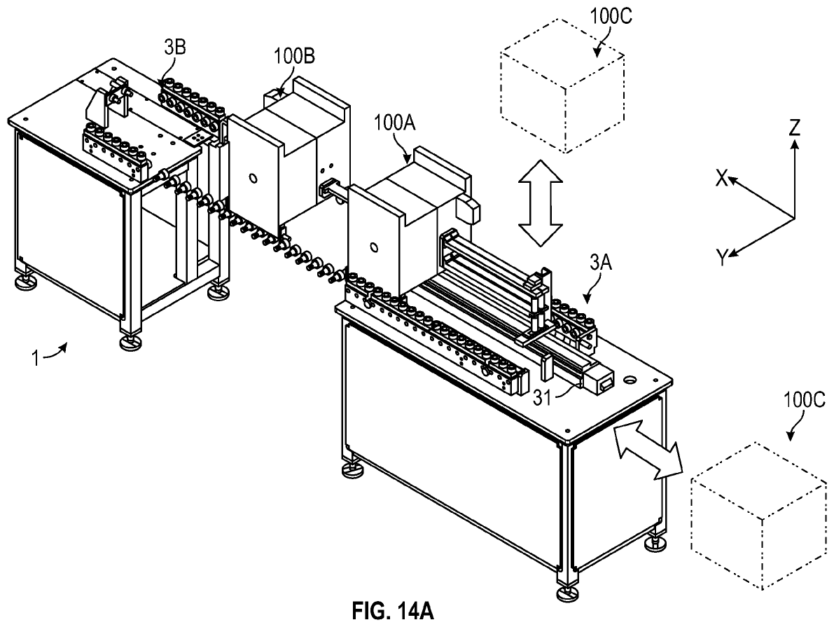

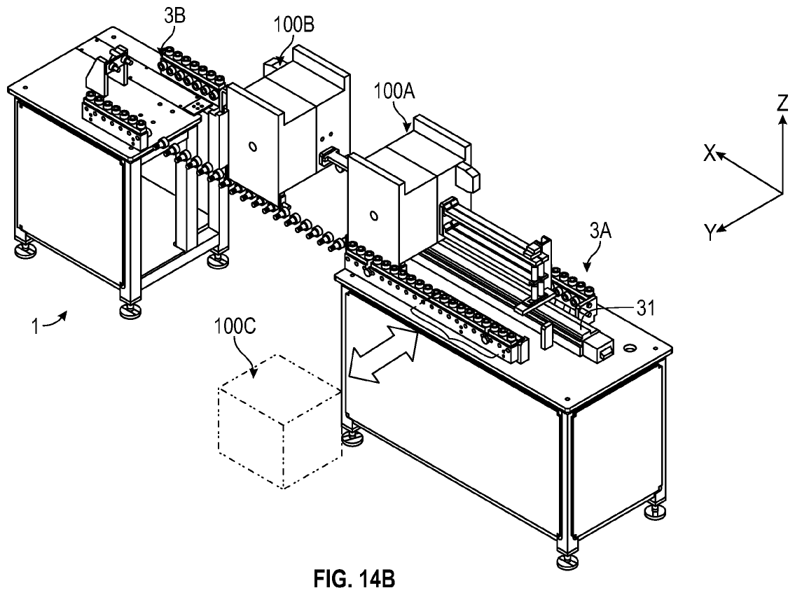

FIG. 14A illustrates directions in which molds are exchanged. More specifically, FIG. 14A illustrates two directions currently used for exchanging the mold 100A inside the injection molding system 1 and a mold 100C outside the injection molding system 1. In a case where the molds 100A and 100C are exchanged in the Z-axis direction, the molds 100A and 100C are exchanged using, for example, a crane. Using a crane typically results in additional time being required due to preparing the crane to be used. In a case where the molds 100A and 100C are exchanged in the X-axis direction, removal of the conveyance unit 31 is needed before exchanging the molds 100A and 100C. Removal of the conveyance unit 31 can also be time consuming. In addition, a cart on which the mold 100C is placed needs to be arranged next to the injection molding system 1 in the X-axis direction.

As illustrated in FIG. 14A, the size (length) of the injection molding system 1 in the X-axis direction is large. This can result in making it difficult to secure floor space in a factory, etc., to install the injection molding system 1 and the cart for exchanging the molds 100A and 100C in the X-axis direction.

Due to the above-described constraints for exchanging molds in the Z-axis and X-axis directions, the following exemplary embodiment of the present disclosure will describe exchanging molds in the Y-direction. FIG. 14B illustrates exchanging molds in the Y-axis direction.

The following description will be provided with respect to conveying machine 3A for discussion purposes. The description is also applicable to conveying machine 3B.

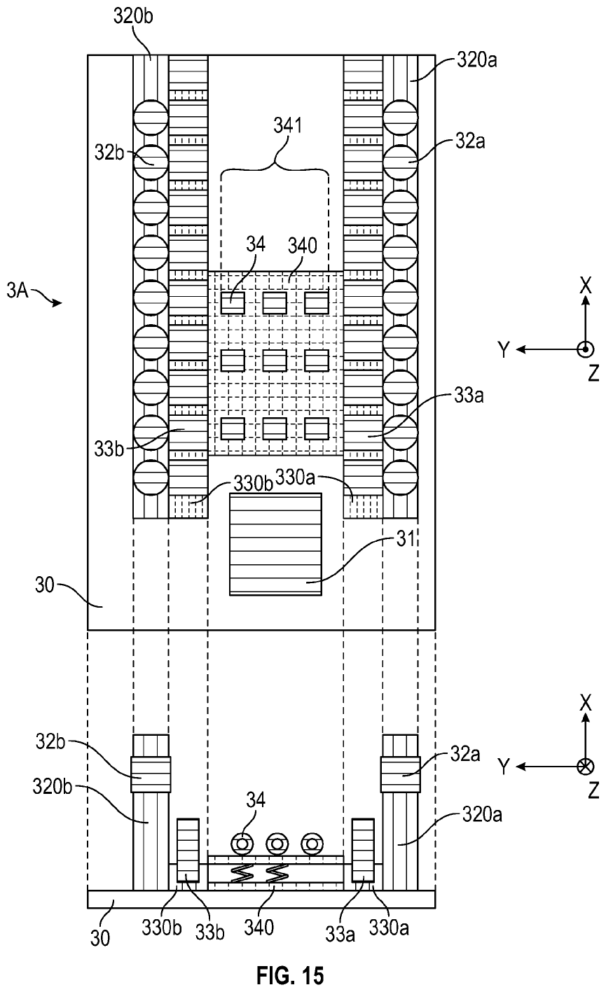

FIG. 15 illustrates a configuration for exchanging the molds 100A and 100C in the Y-axis direction. More specifically, FIG. 15 illustrates a top view and a front view of the conveying machine 3A. The mold 100A is omitted from FIG. 15. The conveying machine 3A includes the frame 30, the conveyance unit 31, the plurality of rollers 32, and the plurality of rollers 33. The conveyance unit 31 is fixed to the frame 30 and moves the mold connected to the conveyance unit 31 in the X-axis direction.

The plurality of rollers 32 includes a row of multiple rollers 32a arranged on the fixed side and a row of multiple rollers 32b arranged on the movable side. The plurality of rollers 33 includes a row of multiple rollers 33a arranged on the fixed side and a row of multiple rollers 33b arranged on the movable side. The multiple rollers 32a, 32b, 33a and 33b define a conveyance path of the mold 100A.

The clamping plate 101a of the mold 100A is supported by the multiple rollers 33a on the fixed side and the clamping plate 102a of the mold 100A is supported by the multiple rollers 33b on the movable side. The multiple rollers 33a are fixed on a support base 330a that is on the fixed side, and the multiple rollers 33b are fixed on a support base 330b. The multiple rollers 32a are fixed on a guide base 320a that is on the fixed side, and the multiple rollers 32b are fixed on the guide base 320b that is on the movable side.

The conveying machine 3A includes a free roller unit 341 for moving (guiding) the mold 100A in the Y-axis direction. The free roller unit 341 includes free rollers 34 and a support base 340 for supporting the free rollers 34. The free roller unit 341 can be fixed to the conveying machine 3A, or attachable to and detachable from the conveying machine 3A so that the free roller unit 34 is attached to the conveying machine 3A only when the molds 100A and 100C are exchanged. The free roller unit 341 includes a jack (not illustrated) that can be used to raise and lower the support base 340 in the Z-axis direction. The configuration for this operation is provided below.

As described above, the support base 330a is a physically different component from the guide base 320a, and the support base 330b is a physically different component from the guide base 320b. Neither the guide base 320a or guide base 320b are fixed on their respective support bases 330a/330b, but are fixed directly onto the frame 30. The support base 330a can be a single component with the guide base 320a, and the support base 330b can be a single component with the guide base 320b.

The support base 330a and the guide base 320a on the fixed side are fixed onto the frame 30 and are not moved or adjusted in the Y-axis direction with respect to the frame 30. The support base 330b and the guide base 320b on the movable side are detachably fixed onto the frame 30, and are adjustable in the Y-axis direction. The support base 330a and guide base 320a can be fixed with respect to each other, and the support base 330b and the guide based 320b can be fixed with respect to each other.

Elongated holes are formed on the frame 30 at different positions in the X-axis direction, and extend along the Y-axis direction. The support base 330b and the guide base 320b can be fixed at an arbitrary position of each of the elongated holes with a fastening member (not illustrated). The fastening member can be, for example, a bolt and nut. The fastening member and the elongated holes adjust and fix the position of the support base 330b and the guide base 320b in the X-axis, Y-axis, and Z-axis directions with respect to the frame 30.

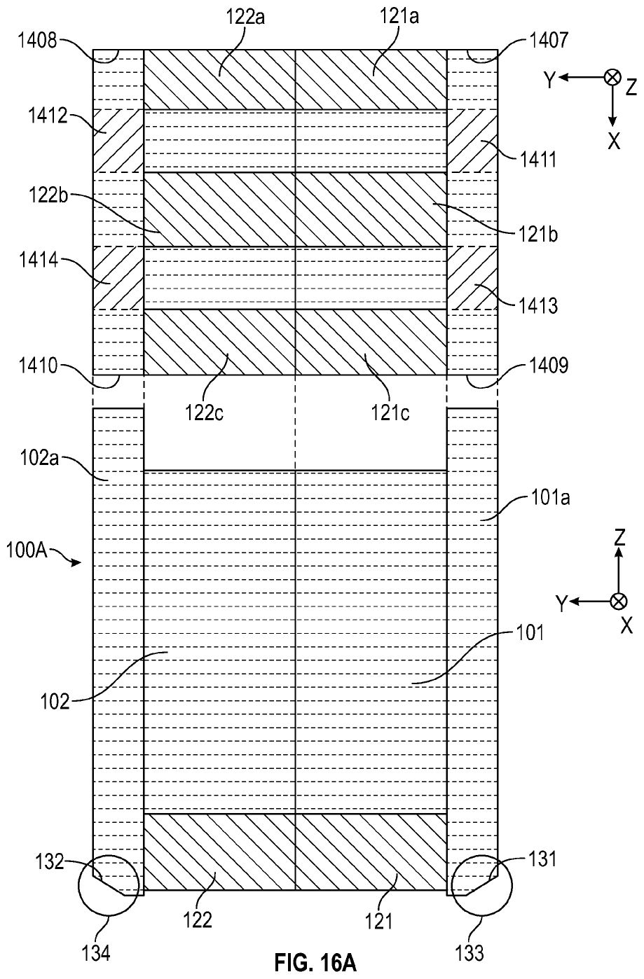

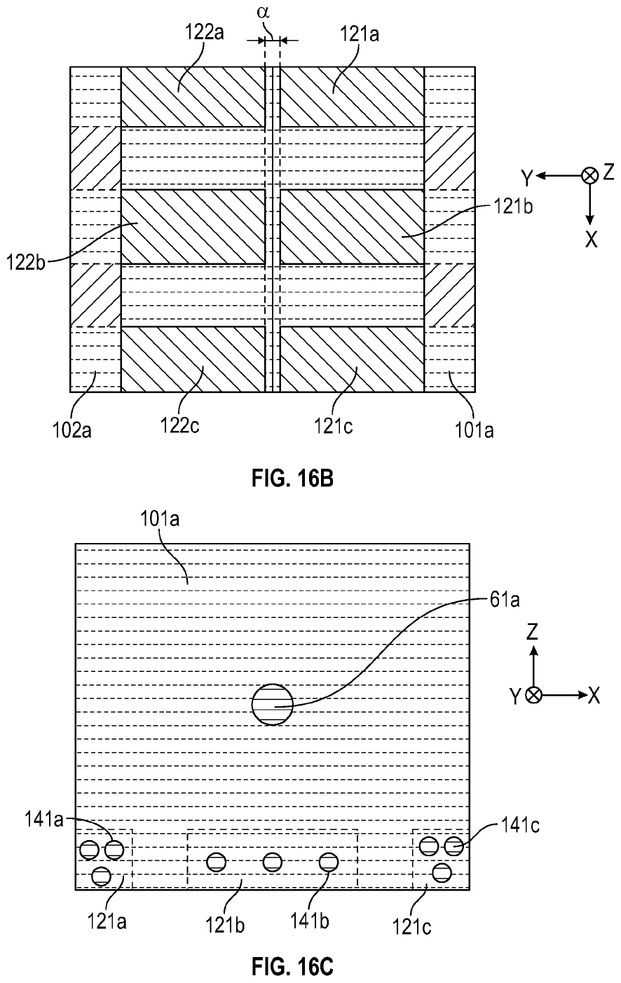

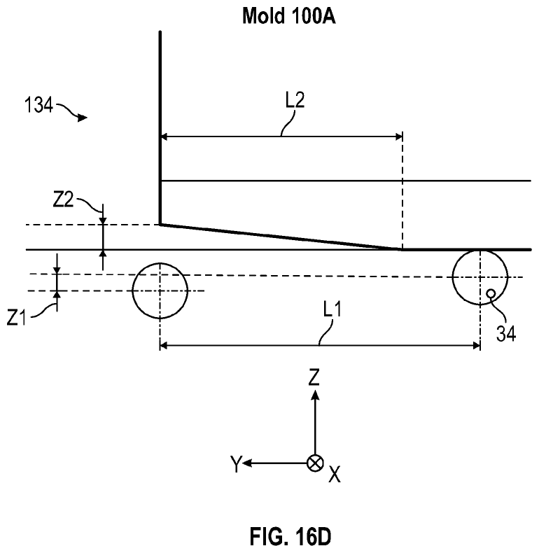

FIG. 16A illustrates a bottom view and a top view of the mold 100A. The mold 100A includes known elements such as the fixed mold 101 fixed at the fixed platen 61 of the injection molding machine 2, and the movable mold 102 fixed at the movable platen 62 of the injection molding machine 2, the clamping plate 101a that contacts the fixed platen 61, and the clamping plate 102a that contacts the movable platen 62.

The mold 100A includes, to smoothly move the mold 100A in the Y-axis direction, a taper portion 133 that is formed at a bottom surface 131 of the clamping plate 101a and a taper portion 134 that is formed at a bottom surface 132 of the clamping plate 102a. The taper portions 133 and 134 are formed in the entire region of the bottom surface 131 and 132 in the X-axis direction respectively. The taper portions 133 and 134 enable suppressing a collision between the mold 100A and the free rollers 34 when the mold 100A is moved in the Y-axis direction. The bottom surface 131 of the clamping plate 101a includes an end 1407 and an end 1409 in the X-axis direction. The bottom surface 132 of the clamping plate 102a includes an end 1408 and an end 1410 in the X-axis direction. Regions 1411-1414 correspond to positions where the fixing mechanisms 610 of the fixed platen 61 and the movable platen 62 clamp the mold 100A.

A support board 121 is fixed to a bottom surface of the fixed mold 101 and a support board 122 is fixed to a bottom surface of the movable mold 102. The support boards 121, 122 fill the area between the bottom surfaces 131, 132, and enable smoothly moving the mold 100A in the Y-axis direction. The support boards 121, 122 are provided at positions facing the free rollers 34 illustrated in FIG. 15.

The support board 121 is divided into three parts, where each part is provided to avoid positions next to the regions 1411 and 1413. A support board 121a is fixed at a location close to the end 1407 and that is between the region 1411 and the end 1407. A support board 121b is fixed between the region 1411 and the region 1413. A support board 121c is fixed at a location close to end 1409 and that is between the region 1413 and the end 1409.

The support board 122 is divided into three parts, where each part is provided to avoid positions next to the regions 1412 and 1414. A support board 122a is fixed at a location close to the end 1408, and that is between the region 1412 and the end 1408. A support board 122b is fixed between the region 1412 and the region 1414. A support board 122c is fixed at a location close to the end 1410 and that is between the region 1414 and the end 1410. The support boards 121, 122 are fixed to avoid positions next to the regions 1411 to 1414 to prevent the support boards 121, 122 and the fixing mechanism 610 from contacting each other. The mold 100C, which is exchanged with the mold 100A, includes similar taper portions and support boards.

FIG. 16B illustrates the size of the support boards 121, 122 with respect to the size of the bottom surface of the mold 100A. More specifically, as illustrated in FIG. 16B, the size of the support boards 121, 122 is smaller than the size of the bottom surface of the mold 100A. A margin a is formed between the support boards 121 and 122. This enables easier attachment of the support boards 121, 122 to the bottom surface of the mold 100A.

FIG. 16C illustrates a side view of the mold 100A. Attachment holes 141a, 141b, 141c are formed in the clamping plate 101a on the fixed side. The support boards 121a, 121b, 121c are attached to the mold 100A using a fastening member (not illustrated), such as a screw, via the attachment holes 141a, 141b, 141c respectively. Attachment holes (not illustrated) are also formed in the clamping plate 102a on the movable side. The support boards 122a, 122b, 122c are attached to the mold 100A in the same way as the support boards 121a, 121b, 121c.

FIG. 16D illustrates a determination method for the smallest dimension of the taper formed in the mold 100A. More specifically, FIG. 7D illustrates an enlarged front view of the free rollers 34 and the taper portion 134 of the mold 100A. The space in the Y-axis direction of the two free rollers 34 is represented by L1, while the misalignment amount in the Z-axis direction of the two free rollers 34 is represented as Z1. The position of the mold 100A is stable if the mold 100A contacts a current free roller 34 until just before it transfers to the next free roller 34. Thus, the taper length L2 of the mold 100A is made shorter than the space L1 between the two free rollers 34. In other words, L2<L1.

There are individual differences in the size of the free rollers 34 and there is variation in the installation positions of the free rollers 34, which together form the misalignment amount Z1. To ensure that the mold 100A does not interfere with the free rollers 34 during transfer due to the misalignment in the Z-axis direction of the free rollers 34, the length in the Z-axis direction of the taper a relation of Z2>Z1. The taper portion 133 has the same configuration as the taper portion 134.

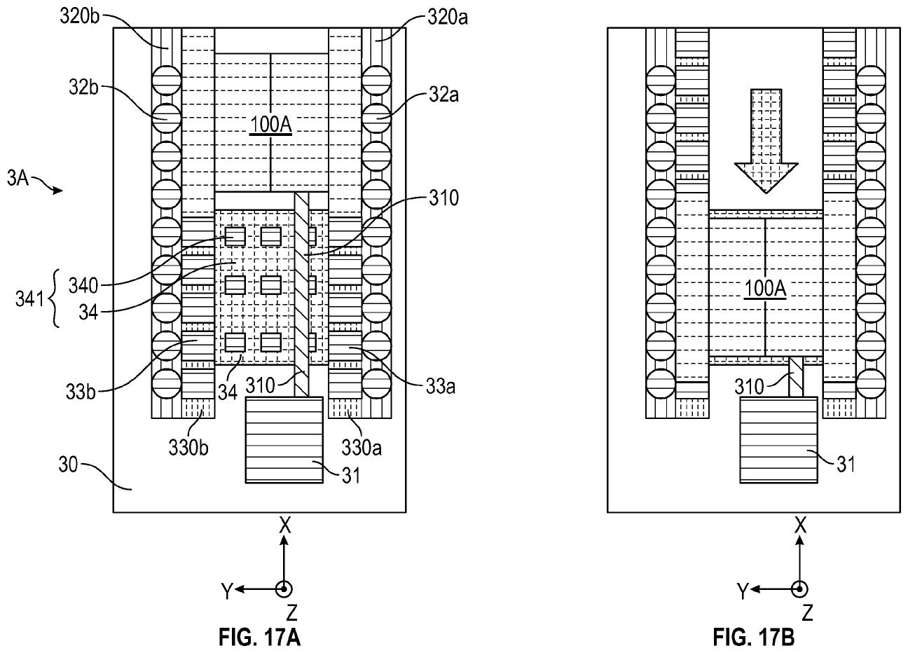

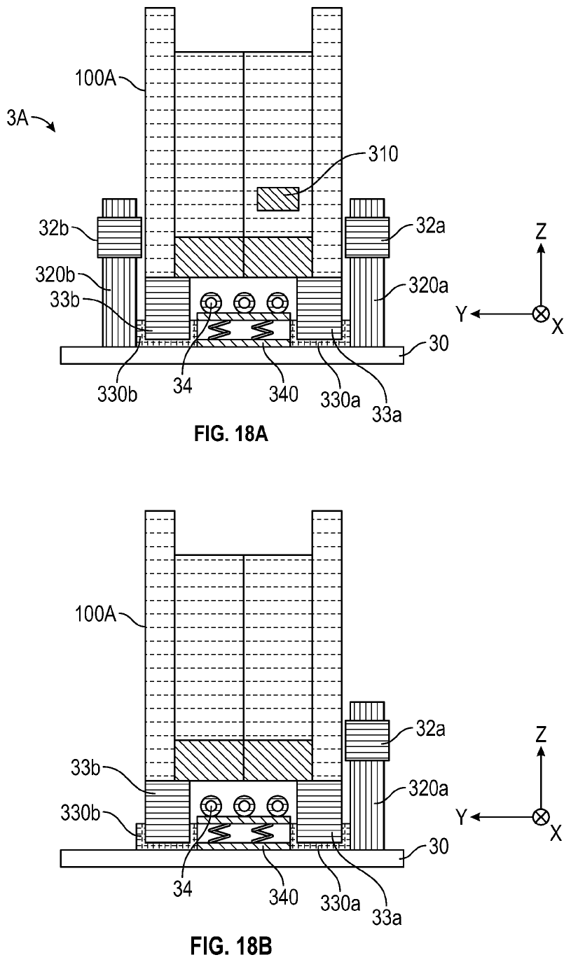

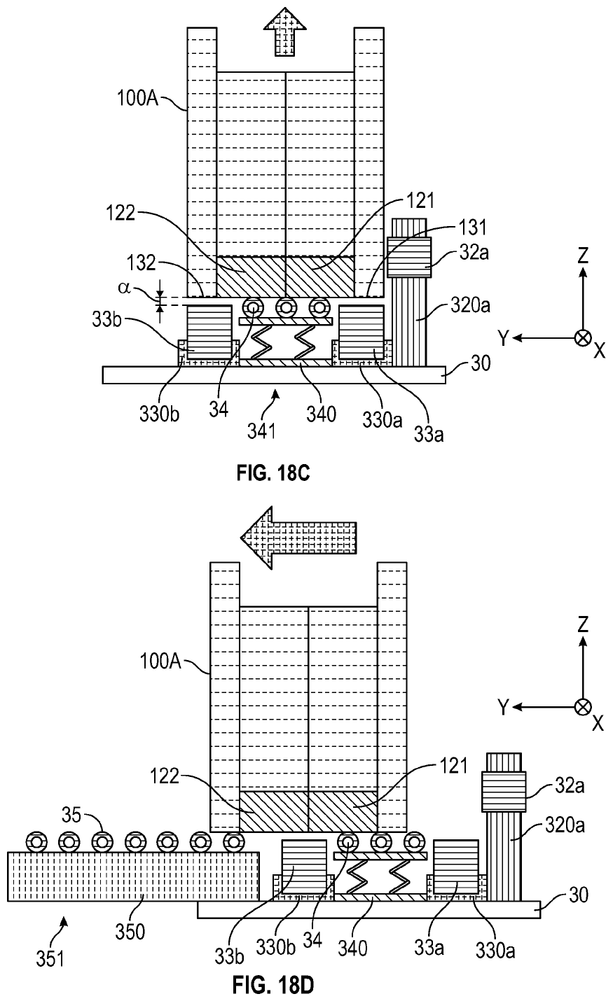

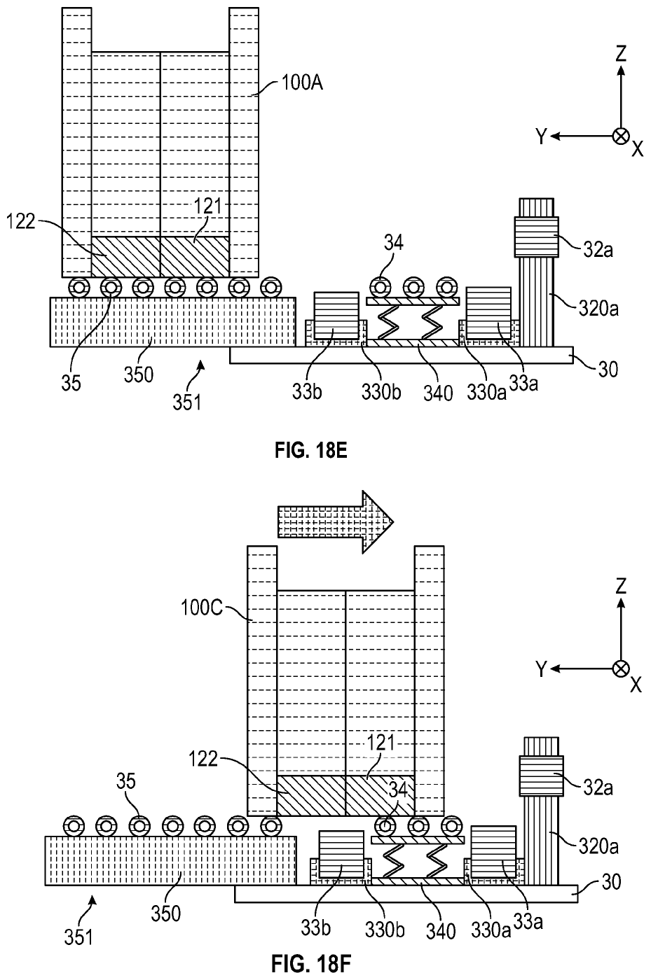

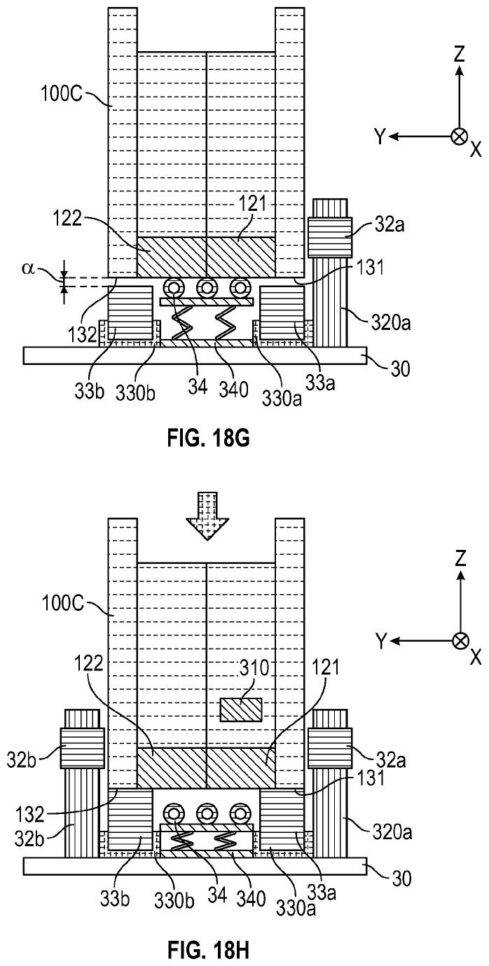

FIGS. 17A-17B and FIGS. 18A-18H illustrates a procedure for exchanging the molds 100A and 100C. FIGS. 17A and 17B illustrates a top view of the conveying machine 3A and FIGS. 18A-18H illustrate a front view of the conveying machine 3A.

In FIGS. 17A-17B, the conveyance unit 31 and the mold 100A are linked by the linking member 310. The mold 100B and the linking member 200 for linking the mold 100A and the mold 100B are omitted from FIGS. 17A-17B.

As illustrated in FIG. 17A, the free roller unit 341 has already been attached to the conveying machine 3A. The mold 100A and the free roller unit 341 do not overlap in the Z-axis direction. When exchanging molds, the conveyance unit 31 moves the mold 100A in the X-axis direction. As illustrated in FIG. 17B, the conveyance unit 31 stops the mold 100A at a position where the mold 100A and the free roller unit 341 overlap in the Z-axis direction. This position is referred to as an exchanging position.

FIG. 18A illustrates the same configuration as in FIG. 18B. In FIG. 18A, the mold 100A is positioned above the free roller unit 341, and the mold 100A and the free roller unit 341 overlap in the Z-axis direction. When exchanging the molds, the operator has to remove the linking member 310 between the conveyance unit 31 and the mold 100A. The operator also has to remove the linking member 200 between the mold 100A and the mold 100B. Then, as illustrated in FIG. 18B, the operator removes the guide base 320b, on which the side rollers 32b are fixed, from the frame 30. This creates a space for moving the mold 100A in the Y-axis direction.

Next, as illustrated in FIG. 18C, the operator raises the support base 340 in the Z-axis direction using, for example, a jack. This results in the free rollers 34 contacting the support boards 121, 122. The operator raises the support base 340 until the bottom surface 131 of the clamping plate 101a and the bottom surface 132 of the clamping plate 102a separate from the bottom rollers 33a, 33b respectively. This separation distance is indicated as “α” in FIG. 18C.

A stopper to regulate a rotation of the free rollers 34 can be installed in the conveying machine 3A. The stopper lock is a position of the mold 100A to prevent the mold 100A from falling down from the conveying machine 3A in a case that the free rollers 34 rotate intentionally when the mold 100A is raised.

Then, as illustrated in FIG. 18D, the operator arranges a cart 351 for exchanging the molds 100A/100C on one side of the conveying machine 3A. The cart 351 includes guide rollers 35 and a support base 350 on which the guide rollers 35 are fixed. In a case that the stopper regulates the rotation of the free rollers 34, the operator unlocks the stopper. The operator moves the mold 100A toward the cart 351 in the Y-axis direction. The mold 100A is guided by the free rollers 34 and the guide rollers 35, and smoothly conveyed to the cart 351.

FIG. 18E illustrates a state where the mold 100A is completely moved from the conveying machine 3A to the cart 351. It is preferable to fix a position of the mold 100A on the cart 351 by using a fixing member (not illustrated), such as a rope, a belt, or a stopper, to regulate a rotation of the guide rollers 35. In this state, the operator moves the cart 351 away from the conveying machine 3A, and can, for example, move the cart 351 to a mold storage location. The operator then unloads the mold 100A from the cart 351 to the mold storage location, and loads a new mold 100C from the mold storage location to the cart 351. The operator then moves the cart 351 to one side of the conveying machine 3A. FIG. 9F illustrates a state where the mold 100C is moved from the cart 351 to the conveying machine 3A in the Y-axis direction. The mold 100C is guided by the free rollers 34 and the guide rollers 35, and smoothly conveyed to the conveying machine 3A.

FIG. 18G illustrates a state where the mold 100C is completely moved from the cart 351 to the conveying machine 3A. Next, as illustrated in FIG. 18H, the operator lowers the support base 340 in the Z-axis direction by using, for example, the jack. The bottom surface 131 of the clamping board 101a and the bottom surface 132 of the clamping board 102a come into contact with the bottom rollers 33a, 33b respectively. The operator lowers the support base 340 at least until the free rollers 34 separate from the support boards 121, 122. The operator then attaches the guide base 320b, on which the side rollers 32b are fixed, to the frame 30. The operator adjusts an attachment position of the guide base 320b based on a width of the mold 100C. The operator connects the conveyance unit 31 and the mold 100C by the linking unit 310, and connects the mold 100C and the mold 100B by the linking unit 200. Exchanging of the molds is then completed.

In the above-described embodiment, the conveyance unit 31 moves the mold 100A to the exchanging position. In another exemplary embodiment, the mold 100A can manually be moved to the exchanging position without using the conveyance unit 31. In this embodiment, it is preferable to remove the linking unit 200 and the linking unit 310 before moving the mold 100A.

In the above-described embodiment, the free roller unit 341 includes the jack, and the operator manually raises and lowers the support base 340. In another exemplary embodiment, an actuator (motor) can be provided in the free roller unit 341, and the support base 340 can be automatically raised and lowered by the actuator.

In the above-described embodiment, the operator manually moves the mold 100A from the conveying machine 3A to the cart 351 and the mold 100C from the cart 351 to the conveying machine 3A. In another exemplary embodiment, an actuator (motor) can be provided in the free roller unit 341 and the cart 351, the actuator drives the free rollers 34 and the guide rollers 35, and the molds 100 are automatically moved.

In the above-described embodiment, the molds 100A/100C are guided in the Y-axis direction by the free rollers 34 and the guide rollers 35. In another exemplary embodiment, a rotating member other than rollers, such as a belt, can be provided, or a slider that is movable in the Y-axis direction can be provided.

In the above-described embodiment, all portions of the guide base 320b are removed from the frame 30. In another exemplary embodiment, only a portion of the guide base 320 that corresponds to the size of the molds 100A/100C can be removed from the frame 30.

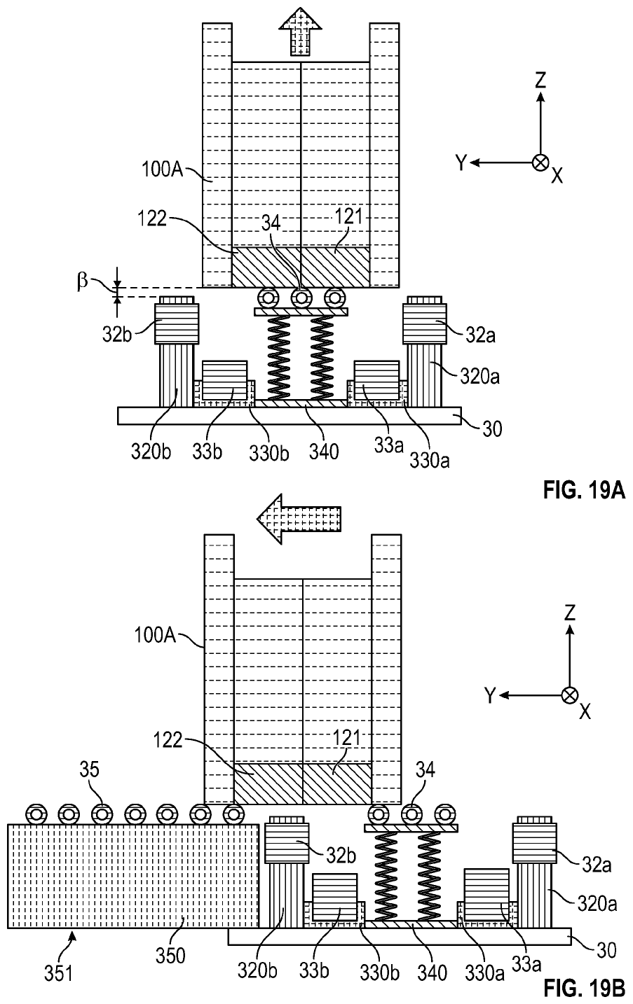

In the above-described embodiment, the guide base 320b on which the side rollers 32b are fixed is removed from the frame 30. In another exemplary embodiment, the exchange for the molds 100A/100C can be performed without removing the guide base 320b from the frame 30. FIGS. 19A and 19B illustrate this procedure.

In FIG. 19A, the operator raises the support base 340 to a higher position than a position illustrated in FIG. 18C. This enables the mold 100A to get over the guide base 320b. In FIG. 19A, a distance between a bottom surface of the mold 100A and an upper surface of the guide base 320b in the Z-axis direction is indicated as “β”.

Then, as illustrated in FIG. 19B, the operator arranges the cart 350 for exchange on one side of the conveying machine 3A. The operator moves the mold 100A toward the cart 351 in the Y-axis direction. The mold 100A is guided by the free rollers 34 and the guide rollers 35, and smoothly conveyed to the cart 351. This configuration enables reduction in time and effort to detach and attach the guide base 320b.

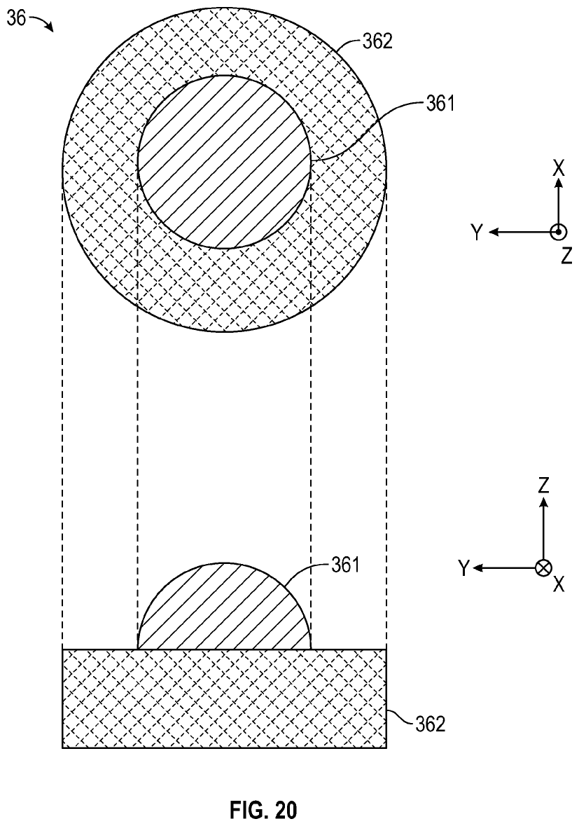

In the above-described embodiment, other than the side rollers 32 and the bottom rollers 33, the free roller unit 341, which is a mechanism for moving (guiding) the molds 100A/100C in the Y-axis direction, needs to be installed in the conveying machine 3A. In another exemplary embodiment, a ball roller 36, which is illustrated in FIG. 20, can be adopted instead of the bottom rollers 33 for moving the molds 100A/100C in the X-axis direction. The ball roller 36 can rotate in any direction, and includes a ball portion 361 and a support portion 362 for supporting the ball portion 361. The ball roller 36 can move the molds 100A/100C in the X-axis direction and in the Y-axis direction.

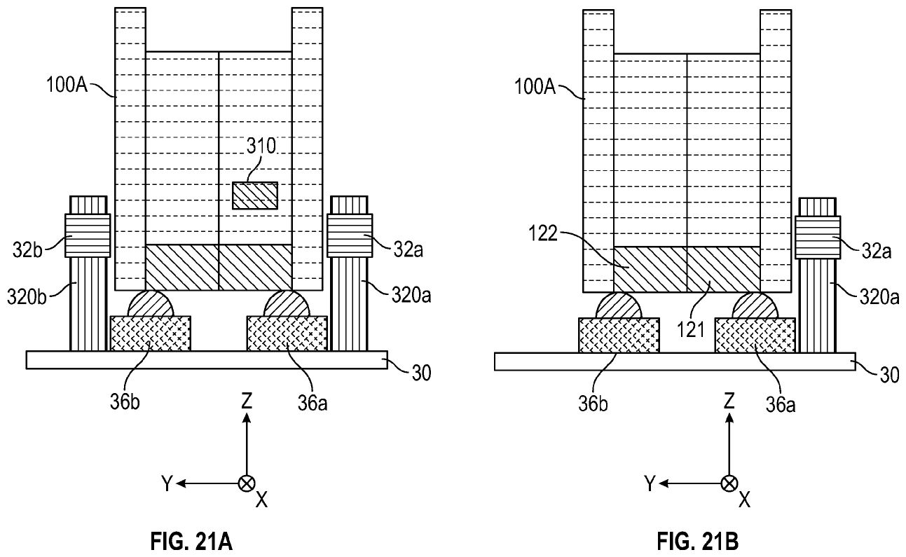

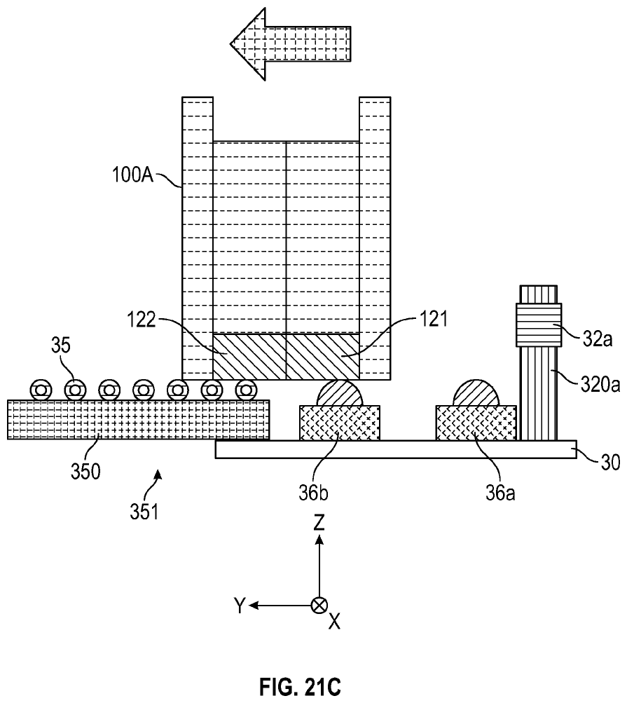

FIGS. 21A, 21B, and 21C illustrate an exchange procedure with the ball roller 36. In FIG. 21A, a row of multiple ball rollers 36a are installed in the X-axis direction instead of the row of multiple bottom rollers 33a, and a row of multiple ball rollers 36b are installed in the X-axis direction instead of the row of multiple bottom rollers 33b. When the injection molding operation is performed, the ball rollers 36a, 36b convey the mold 100A in the X-axis direction.

FIG. 21B illustrates a state where the guide base 320b, on which the side rollers 32b are fixed, is removed from the frame 30. This creates a space for moving the mold 100A in the Y-axis direction. Then, as illustrated in FIG. 21C, the operator arranges the cart 351 on one side of the conveying machine 3A. The operator moves the mold 100A toward the cart 351 in the Y-axis direction. The mold 100A is guided by the ball rollers 36 and the guide rollers 35, and smoothly conveyed to the cart 351. This configuration allows for not requiring installation of the free roller unit 341.

In the above-described embodiment, the ball roller 36 is located along the frame 30 in the X-axis direction. In another exemplary embodiment, the ball rollers 36 can be located at only a portion of the frame 30 that corresponds to the size of the molds 100A/100C.

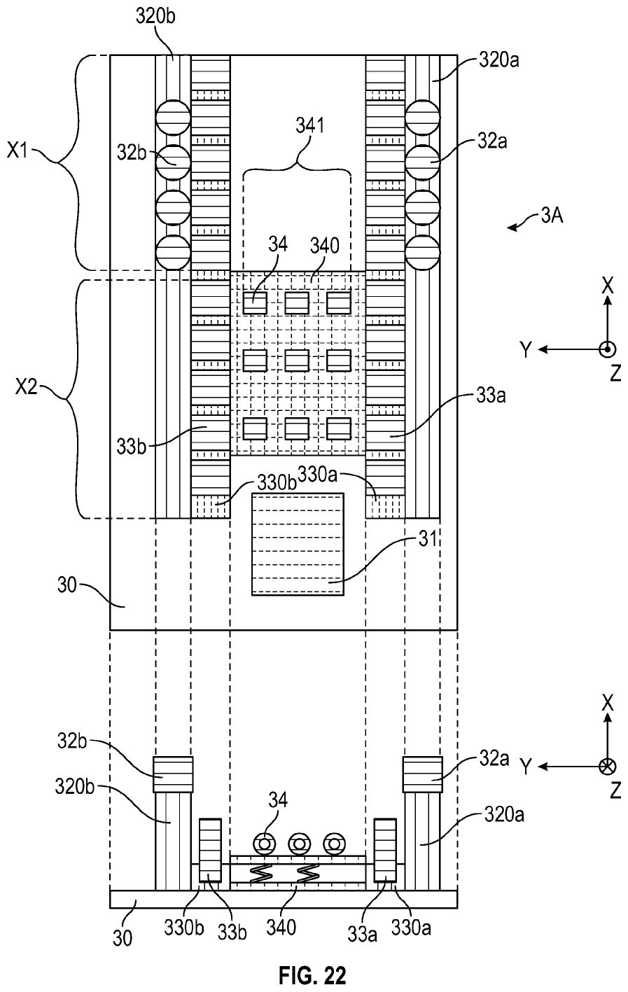

In the above-described embodiment, the side rollers 32 are surrounded by the guide base 320 in the Z-axis direction. In another exemplary embodiment, a plurality of holes can be formed on an upper surface of the guide base 320 and a rotational axis of the side roller 32 can be inserted into the hole. FIG. 22 illustrates a top view and a front view of this configuration.

As illustrated in the front view of FIG. 22, the side rollers 32a/32B protrude from the guide base 320 in the Z-axis direction. As illustrated in the top view of FIG. 22, the side rollers 32a/32b are provided in a region X1 but not in the region X2 in the X-axis direction. The region X1 is a region near the injection molding machine 2 and the region X2 is a region farther from the injection molding machine 2, and which includes the exchanging position for the molds 100A/100C. The side rollers 32a/32b are provided in the region X1 to prevent a positional shift of the mold in the Y-axis direction when a mold is inserted into the injection molding machine 2.

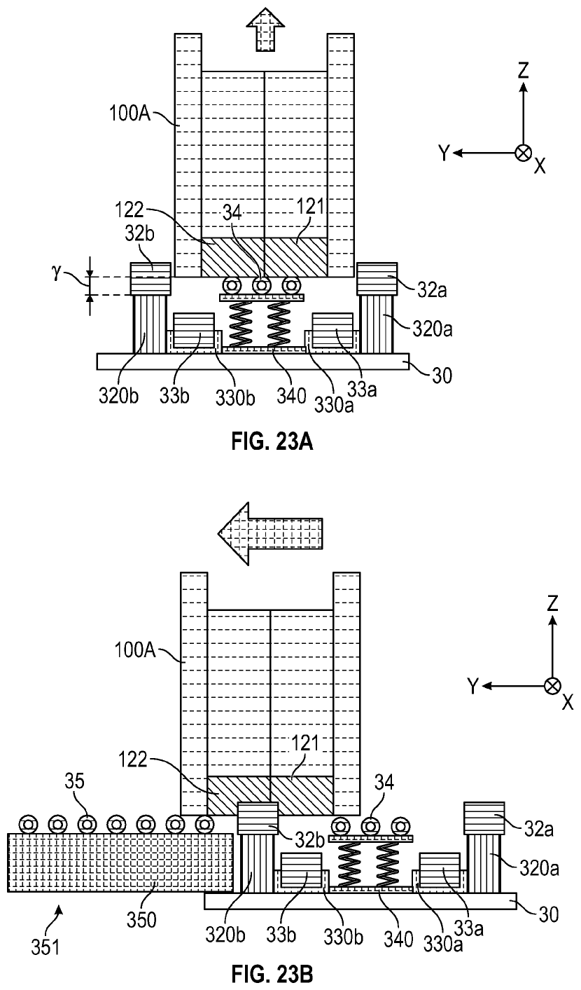

FIGS. 23A and 23B illustrate an exchange procedure for the molds 100A/100C using the configuration of FIG. 22. In FIG. 23A, the operator raises the support base 340 by using, for example, the jack, so that the bottom surface of the mold 100A reaches a higher position than the upper surface of the guide base 320b. In FIG. 23A, a distance between the bottom surface of the mold 100A and the upper surface of the guide base 320b in the Z-axis direction is indicated as “y”.

In this configuration, the side rollers 32a/32b are provided on the guide base 320 but not next to the exchanging position. Therefore, the operator does not have to raise the mold 100A to the higher position as illustrated in FIG. 19A and does not have to remove the side rollers 32 when exchanging the molds.

Then, as illustrated in FIG. 23B, the operator arranges the cart 351 for exchange on one side of the conveying machine 3A. The operator moves the mold 100A toward the cart 351 in the Y-axis direction. The mold 100A is guided by the free rollers 34 and the guide rollers 35, and smoothly conveyed to the cart 351. This configuration enables reduction reduce in time and effort to detach and attach the guide base 320b.

In the above-described embodiment, each of the support boards 121, 122 is divided into three parts and attached to the bottom surface of the mold 100A. In another exemplary embodiment, each of the support boards 121, 122 can be divided into two parts, or four or more parts.

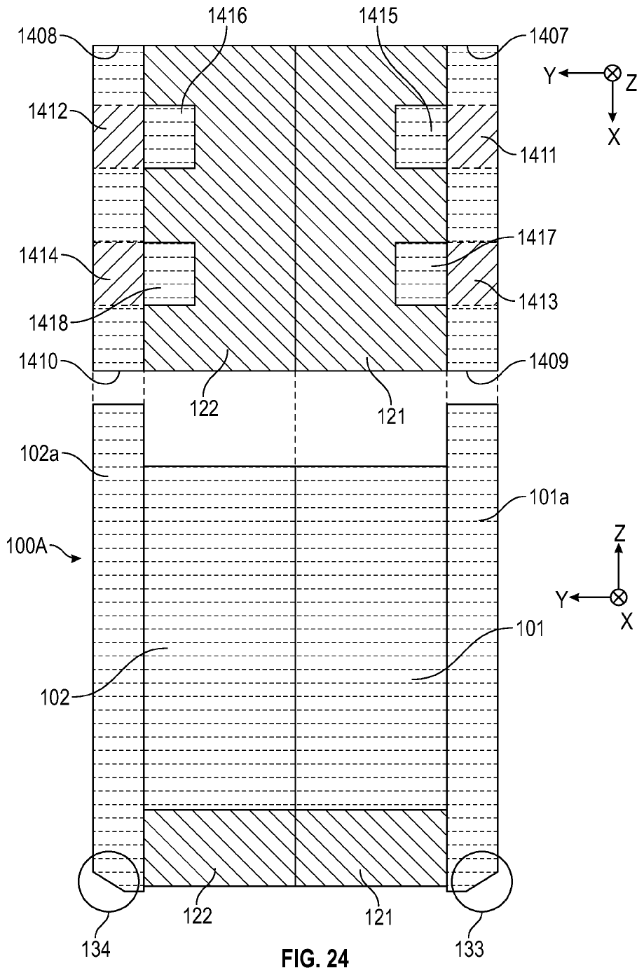

As illustrated in FIG. 24, it is not necessary to divide the support boards 121, 122 if each of the support boards 121, 122 has a shape to avoid the clamp 610. The support boards 121, 122 illustrated in FIG. 24 include regions 1415-1418, which are spaces, such as holes.

In the above-described embodiment, the support boards 121, 122 are fixed to the mold 100A, and the injection molding operation is performed in a state where the support boards 121, 122 are fixed to the mold 100A. In another exemplary embodiment, the support boards 121, 122 can be attached to a mold only when the molds are exchanged, and the support boards 121, 122 can be detached from a mold after the molds are exchanged. In this case, it is preferable to divide the support boards 121, 122 into two not three parts, and attach them to edge regions of the bottom surface of the mold in the X-axis direction to make it easier to detach them.

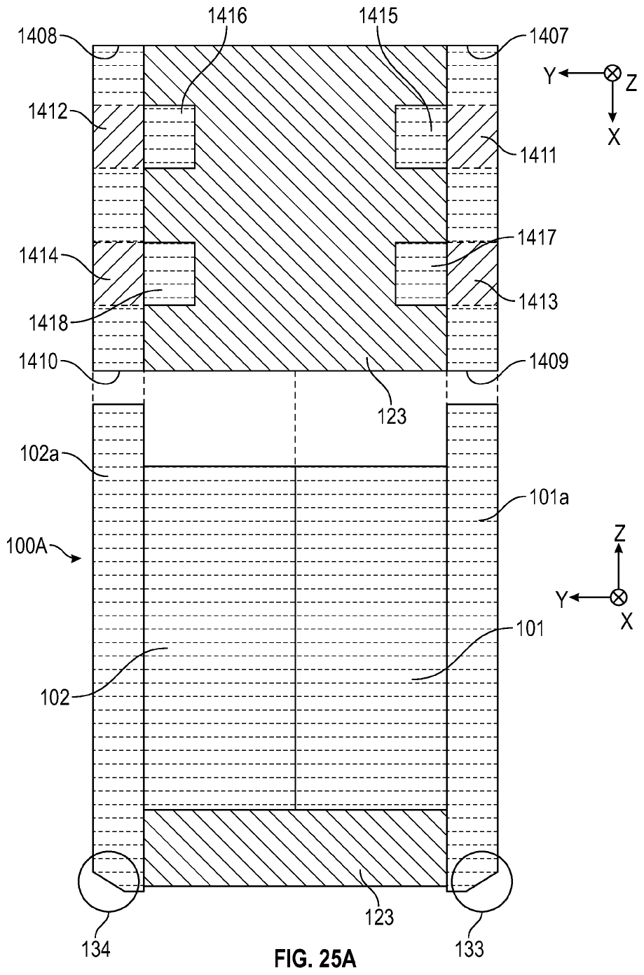

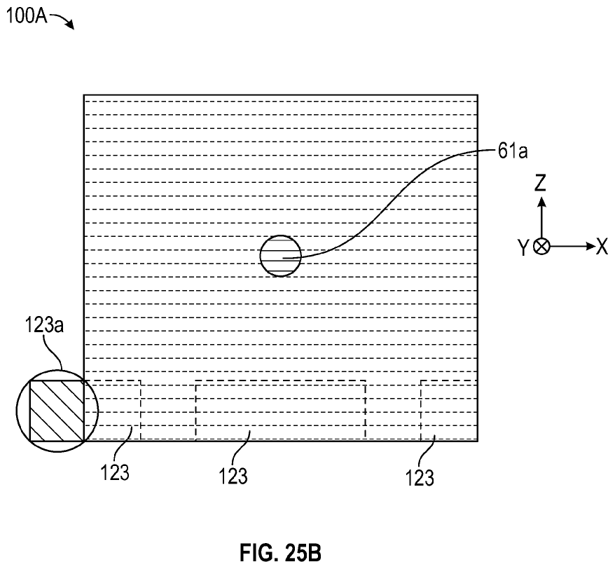

In another exemplary embodiment, the support board may not be divided into the support board 121 on the fixed side and the support board 122 on the movable side. As illustrated in FIG. 25A, one support board 123 can be attached to the bottom surface of the fixed mold 101 and the bottom surface of the movable mold 102. FIG. 25B illustrates a side view of the mold 100A to which the support board 123 is attached. The support board 123 has a protruding portion 123a that protrudes from the mold 100A in the X-axis direction. After the molds 100A/100C are exchanged, the operator can detach the support board 123 from the mold 100A by holding the protruding portion 123a and pulling the support board 123 in the X-axis direction. The protruding portion 123a can have a handle shape.

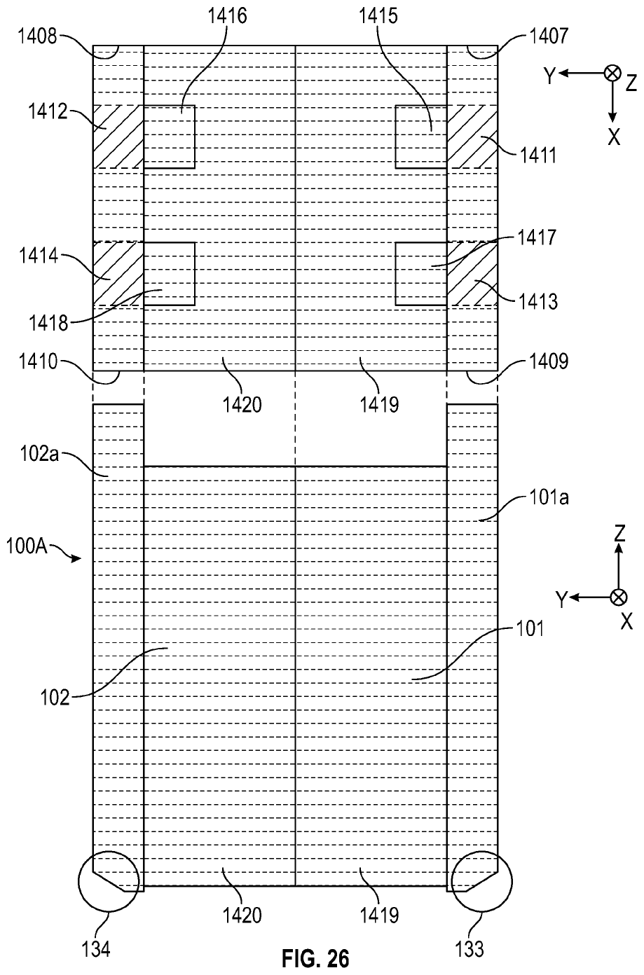

FIG. 26 illustrates another exemplary embodiment where the shape of the mold 100A can be changed without providing the support board. Grooves 1415, 1417 are formed at positions next to the clamped regions in a bottom surface 1419 of the fixed mold 101. Grooves 1416, 1418 are formed at positions next to the clamped regions in a bottom surface 1420 of the movable mold 101. The sizes of the grooves 1415-1418 can vary based on the mold 100A being used in other injection molding machine and the clamped regions being shifted.

In the above-described embodiment, the taper portions 133, 134 are formed in the mold 100A. In another exemplary embodiment, only the taper portion 133 can be formed in the mold 100A or only the taper portion 134 can be formed in the mold 100A.

The exchange procedure was described above with reference to the conveying machine 3A. The above-description is also applicable to an exchange procedure using the conveying machine 3B.

In the above-described embodiment the conveyance unit 31 is installed in the conveying machine 3A and conveying machine 3B, which enables the above-described exchanging method to be implemented in a configuration where mold 100A and 100B are alternately inserted into the injection molding system 1. This enables an injection molding operation to be performed with one mold while a second mold is exchanged with a third mold.

In the above-described embodiment, two molds are installed in the injection molding system 1. In another exemplary embodiment, the above exchanging method can be adopted to a configuration where only one mold is installed in the injection molding system 1.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A conveyance system for conveying a mold into an injection molding machine comprising:
a conveying machine configured to convey the mold; and
a supporting member configured to movably support the conveying machine,
wherein the improvement to the conveyance system includes a guide member configured to guide a movement of the conveying machine by the supporting member in a direction other than an X-axis direction between a first position where the mold can be conveyed from the conveying machine to the injection molding machine and a second position that is different from the first position.

2. The conveyance system according to claim 1, wherein the guide member is further configured to guide the movement of the conveying machine in a direction that is parallel to a floor the conveying machine is located on and that intersects with a conveying direction the mold is conveyed by the conveying machine.

3. The conveyance system according to claim 1, wherein the guide member is further configured to guide the movement of the conveying machine in a direction that is parallel to a conveying direction the mold is conveyed by the conveying machine.

4. The conveyance system according to claim 1, wherein the supporting member is a rotating member and the guide member is a rail that engages the rotating member.

5. The conveyance system according to claim 1, wherein the guide member is configured to regulate a movement of the conveying machine in a direction that intersects with an extending direction of the guide member.

6. The conveyance system according to claim 1, further comprising a fixing unit configured to fix the conveying machine at the first position.

7. The conveyance system according to claim 6, wherein the fixing unit is configured to fix the conveyance unit to a floor.

8. The conveyance system according to claim 6, wherein the fixing unit is configured to fix the conveyance unit to the injection molding machine.

9. The conveyance system according to claim 6, wherein the fixing unit is configured to extend over the guide member and regulate a movement of the conveying machine in an extending direction of the guide member.

10. An injection molding system comprising:
an injection molding apparatus configured to perform injection molding with a mold;
a conveying machine configured to convey the mold into the injection molding machine; and
a supporting member configured to movably support the conveying machine,
wherein the improvement to the injection molding systems includes a guide member configured to guide a movement of the conveying machine by the supporting member in a direction other than an X-axis direction between a first position where the mold can be conveyed from the conveying machine to the injection molding machine and a second position that is different from the first position.

11. The injection molding system according to claim 10, wherein the guide member is configured to guide the movement of the conveying machine in a direction that is parallel to a floor the conveying machine is located on and that intersects with a conveying direction the mold is conveyed by the conveying machine.

12. The injection molding system according to claim 11, wherein the injection molding machine includes a fixed platen for securing a fixed mold included in the mold and a movable platen for securing a movable mold included in the mold, and wherein in a state where the mold is at the second position, an upstream end surface of a frame of the conveying machine is positioned on a downstream side of a surface of the fixed platen facing the movable platen in the first direction.

13. An injection molding system comprising:
an injection molding apparatus configured to perform injection molding with a mold; and
a conveying apparatus configured to move the mold in a predetermined direction along a supporting plane and insert the mold into the injection molding apparatus,
wherein an improvement to the injection molding system includes:
a guide member located at an exchanging position in the conveying apparatus and configured to guide the mold in an intersecting direction that is parallel with the supporting plane and intersects with the predetermined direction,
wherein the conveying apparatus is configured to move a first mold in the predetermined direction until the first mold reaches the exchanging position,
wherein the first mold is guided by the guide member in the intersecting direction for unloading the first mold from the injection molding system, and
wherein a second mold is guided by the guide member in the intersecting direction for loading the second mold into the injection molding system.

14. A method for exchanging a first mold inside an injection molding system and a second mold outside the injection molding system wherein the injection molding system includes an injection molding apparatus configured to perform injection molding with a mold and a conveying apparatus configured to move the mold in a predetermined direction along a supporting plane and insert the mold into the injection molding apparatus, the method comprising:
a moving step for moving the first mold in the predetermined direction until the first mold reaches an exchanging position where a guide member is located, wherein the exchanging position is located in the conveying apparatus,
wherein an improvement to the injection molding system includes:
an unloading step for unloading the first mold from the injection molding system, wherein the first mold is guided by the guide member in an intersecting direction that is parallel with the supporting plane and intersects with the predetermined direction, and
a loading step for loading the second mold to the injection molding system, wherein the second mold is guided by the guide member in the intersecting direction.

15. The method according to claim 14, wherein the mold at the exchanging position does not contact with the guide member in a vertical direction, the method further comprising:
a raising step for raising the guide member so that the guide member contacts the first mold before the unloading step, and
a lowering step for lowering the guide member so that the guide member separates from the second mold after the loading step.

16. The method according to claim 15, wherein the conveying apparatus includes a side conveying member configured to move the mold in the predetermined direction, wherein the side conveying member is located next to the mold in the intersecting direction, the method further comprising:
a removing step for removing the side conveying member from the conveying apparatus before the unloading step, and
an installing step for installing the side conveying member on the conveying apparatus after the loading step.

17. The method according to claim 15, wherein the conveying apparatus includes a bottom conveying member configured to move the mold in the predetermined direction, wherein the bottom conveying member is located under the mold in the vertical direction, and wherein, in the raising step, the guide member is raised at least until the mold does not contact with the bottom conveying member in the vertical direction.

18. The method according to claim 15, wherein the conveying apparatus includes a side conveying member configured to move the mold in the predetermined direction, wherein the side conveying member is located next to the mold in the intersecting direction, and wherein, in the raising step, the guide member is raised at least until a bottom surface of the mold is above an upper surface of the side conveying member.

19. The method according to claim 15, further comprising:
a locking step for locking a movement of the guide member so that the guide member does not guide the mold in the intersecting direction before the raising step, and
an unlocking step for unlocking the movement of the guide member so that the guide member guides the mold in the intersecting direction before the unloading step.

20. The method according to claim 14, further comprising an attaching step for attaching the guide member to the conveying apparatus before the moving step.

21. The method according to claim 14, wherein the mold at the exchanging position contacts the guide member in a vertical direction, and wherein the guide member is configured to move the mold in the predetermined direction and the intersecting direction, wherein the guide member is located under the mold in a vertical direction.

22. The method according to claim 14, wherein the conveying apparatus includes a side conveying member configured to move the mold in the predetermined direction, wherein the side conveying member is located next to the mold in the intersecting direction, the method further comprising:
a removing step for removing the side conveying member from the conveying apparatus before the unloading step, and
an installing step for installing the side conveying member on the conveying apparatus after the loading step.

23. An injection molding system comprising:
an injection molding apparatus configured to perform injection molding with a mold; and a conveying apparatus configured to move the mold in a predetermined direction along a supporting plane and insert the mold into the injection molding apparatus,
wherein an improvement to the injection molding system includes the conveying apparatus including:
a side conveying member configured to move the mold in the predetermined direction and configured to be located next to the mold in an intersecting direction that intersects with the predetermined direction and is parallel with the supporting plane, and
a bottom conveying member configured to move the mold in the predetermined direction and the intersecting direction, and configured to be located under the mold in a vertical direction.

24. The injection molding system according to claim 23, wherein the side conveying member is configured to be removable from the conveying apparatus.

25. The injection molding system according to claim 23, wherein the bottom conveying member is a ball roller.

26. A mold for an injection molding system, the mold comprising:
a first part and a second part, wherein a cavity is formed between the first part and the second part;
a first clamping plate configured to be fixed to a side surface of the first part; and
a second clamping plate configured to be fixed to a side surface of the second part,
wherein an improvement to the mold includes:
a first support member configured to be fixed to a bottom surface of the first part, and
a second support member configured to be fixed to a bottom surface of the second part.

27. The mold according to claim 26,
wherein the first clamping plate and the second clamping plate are clamped by clamping members in the injection molding system, and
wherein the first support member and the second support member are configured to be fixed to the bottom surface of the first part and the bottom surface of the second part respectively to avoid the clamping members.

28. The mold according to claim 26,
wherein the second part is configured to be movable relative to the first part in a predetermined direction,
wherein the first support member and the second support member are divided into a plurality of members in a direction orthogonal to the predetermined direction and is parallel with the bottom surface of the first part and the bottom surface of the second part.

29. The mold according to claim 26,
wherein the first support member is configured to fill a gap between the bottom surface of the first part and a bottom surface of the first clamping plate, and
wherein the second support member is configured to fill a gap between the bottom surface of the second part and a bottom surface of the second clamping plate.

30. The mold according to claim 26,
wherein the mold is configured to be guided by a plurality of guide members arranged in a predetermined direction,
wherein a bottom surface of the first clamping plate has a taper portion, and
wherein, when viewed in a direction orthogonal to the predetermined direction and parallel with the bottom surface of the first part, the taper portion is inclined to the predetermined direction.

31. The mold according to claim 26,
wherein the mold is configured to be guided by a plurality of guide members arranged in a predetermined direction,
wherein a bottom surface of the second clamping plate has a taper portion, and
wherein, when viewed in a direction orthogonal to the predetermined direction and parallel with the bottom surface of the second part, the taper portion is inclined to the predetermined direction.
